(19) United States
(12) Patent Application Publication
(10) Pub. No.: US 2026/0356599 A1
(43) Pub. Date: Nov. 12, 2026

(54) AUTOMATED ULD UNLOADING AND CART LOADING SYSTEM USING GANTRY-BASED ROBOTIC ARCHITECTURE

(71) Applicant: Labo, Inc., Washougal, WA (US)

(72) Inventors: David Bruce McCalib Jr, Ridgefield, WA (US); Vadim Tikhanoff, Genoa (IT)

(73) Assignee: Labo, Inc., Washougal, WA (US)

(21) Appl. No.: 19/669,729

(22) Filed: May 6, 2026

Related U.S. Application Data
(60) Provisional application No. 63/800,908, filed on May 6, 2025.

(51) Int. Cl. B65G 47/49; B25J 9/16; B65G 47/91; B65G 47/94; B65G 67/46; B65G 69/16

(52) U.S. Cl. CPC B65G 47/493; B25J 9/163; B25J 9/1666; B65G 47/917; B65G 47/945; B65G 67/46; B65G 69/16; B65G 2203/041; B65G 2203/044; B65G 2814/0302

(57) ABSTRACT

An automated system and a method for unloading and sorting Material to be Handled (MTBH) from a Unit Load Device (ULD) are disclosed. The system comprises a lifting and tilting mechanism, a staging interface, a primary robotic handling system, a perception system, a robotic end effector, a transfer system, a scanning station, and a downstream sorting and loading system. The system receives an ULD, lifts it to a discharge height, tilts it to discharge MTBH onto a staging interface, detects and identifies MTBH using a perception system, grips and lifts MTBH using a robotic system, transfers MTBH to a conveyor system, scans MTBH to extract identification data, and dynamically sorts and loads MTBH into destination-specific containers.

### CROSS-REFERENCE TO RELATED APPLICATIONS

This application claims the benefit of U.S. provisional patent application Ser. No. 63/800,908, filed on May 6, 2025, the contents of which are incorporated herein by reference in their entirety.

### BACKGROUND

This disclosure pertains to the field of automated logistics, material handling, and warehouse management systems. More particularly, it relates to an integrated robotic solution for the efficient and autonomous unloading of Unit Load Devices (ULDs), as commonly utilized in air cargo and freight operations. Recognizing the spatial and payload constraints that make direct robotic unloading from within the ULD impractical for high-throughput operations, there is a need for a solution that better supports quick and controlled ULD unloading operations, allowing a more efficient facility layout and higher rate of throughput.

### BRIEF SUMMARY

The system and method are disclosed for automated unloading and sorting Material to be Handled (MTBH) from a Unit Load Device (ULD). The system includes a lifting and tilting mechanism that is configured to receive a ULD in a first orientation, elevate the ULD to a discharge height, and rotate the ULD to a discharge orientation so as to initiate a gravity-assisted discharge of the MTBH.

Adjacent to the lifting and tilting mechanism, the system includes a staging interface that is configured to receive MTBH discharged from the ULD and to maintain the discharged MTBH within an open-access picking region that is accessible from above. The lifting and tilting mechanism and the staging interface are configured to operate in coordination so that the gravity-assisted discharge of the MTBH occurs in a controlled manner that preserves pickable surfaces of individual MTBH within the open-access picking region.

A singulation mechanism associated with the staging interface is provided to reduce any multi-layer accumulation of discharged MTBH into at least one of a reduced-height distribution or a single-layer distribution suitable for robotic picking. Positioned over the open-access picking region, a primary robotic handling system comprises at least one multi-axis robot with a robotic end effector configured to identify, engage, and remove individual MTBH from the staging interface based on a detected position and a detected orientation.

A perception system generates spatial data representing at least the detected position and the detected orientation of individual MTBH within the open-access picking region and provides this spatial data to the primary robotic handling system for pick planning. A transfer system receives each individual MTBH removed by the primary robotic handling system and transports each MTBH along a defined flow path. A scanning station disposed along that flow path is configured to extract identification data associated with each individual MTBH. Finally, a downstream sorting and loading system receives each MTBH from the transfer system and places each MTBH into one of a plurality of destination-specific containers based on the identification data extracted by the scanning station.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an automated ULD unloading system 100 in accordance with one embodiment.

FIG. 2 illustrates a routine 200 in accordance with one embodiment.

FIGS. 3A-3E illustrate a ULD unloading process 300 in accordance with one embodiment.

FIG. 4 illustrates a multi-axis gantry robotic system with gripping end effectors 400 in accordance with one embodiment.

FIG. 5 illustrates an automated ULD unloading system 500 in accordance with one embodiment.

FIG. 6 illustrates an automated ULD unloading system array 600 in accordance with one embodiment.

FIG. 7 illustrates a robotic unloading system array 700 in accordance with one embodiment.

FIG. 8 illustrates a perspective view of a robotic unloading system 800 that may be used to accept MTBH from the staging interface through a robotic handling system onto a conveyor or belt system and thence to a downstream sorting and loading system according to various embodiments of the present disclosure.

FIG. 9A illustrates a side elevation view of a robotic handling system 900 according to various embodiments of the present disclosure.

FIG. 9B illustrates a front elevation view of the robotic handling system 900 in accordance with one embodiment.

FIG. 10 illustrates an embodiment of a computer system 1000 to implement components and process steps of the system described herein.

FIG. 11 illustrates MTBH calculated picking data 1100 in accordance with one embodiment.

FIG. 12 illustrates an unloading control system 1200 in accordance with one embodiment.

FIG. 13 illustrates a container loading control system 1300 in accordance with one embodiment.

FIG. 14 illustrates a load stabilization control system 1400 in accordance with one embodiment.

FIG. 15 illustrates an end-to-end control system diagram 1500 in accordance with one embodiment.

FIG. 16 illustrates an automated truck unloading routine 1600 in accordance with one embodiment.

FIG. 17 illustrates a pick routine for individual articulated robot 1700 in accordance with one embodiment.

FIG. 18 illustrates an automated truck unloading flow diagram 1800 in accordance with one embodiment.

FIG. 19 illustrates a detection cache flow diagram 1900 in accordance with one embodiment.

FIG. 20 illustrates a planner flow diagram 2000 in accordance with one embodiment.

FIG. 21 illustrates an execution flow diagram 2100 in accordance with one embodiment.

FIGS. 22A-22I illustrate a suction gripping apparatus 2200 comprising a suction gripping unit 2202 in accordance with one embodiment.

FIGS. 23A-23C illustrate a guiding support pin 2300 in accordance with one embodiment.

FIGS. 24A-24C illustrate a gripping end effector 2400 in accordance with one embodiment.

FIG. 25 illustrates a robot arm with gripping end effector system 2500 in accordance with one embodiment.

FIG. 26 illustrates a top pick scenario with a conventional suction cup array 2600 in accordance with one embodiment.

FIG. 27 illustrates a side pick scenario with a conventional suction cup array 2700 in accordance with one embodiment.

FIG. 28 illustrates attachment forces during a side pick scenario 2800 in accordance with one embodiment.

FIGS. 29A-29B illustrate a suction gripping apparatus 2900 in accordance with one embodiment.

FIGS. 30A-30B illustrate a suction gripping apparatus 3000 in accordance with one embodiment.

FIGS. 31A-31B illustrate a suction gripping apparatus 3100 in accordance with one embodiment.

### DETAILED DESCRIPTION

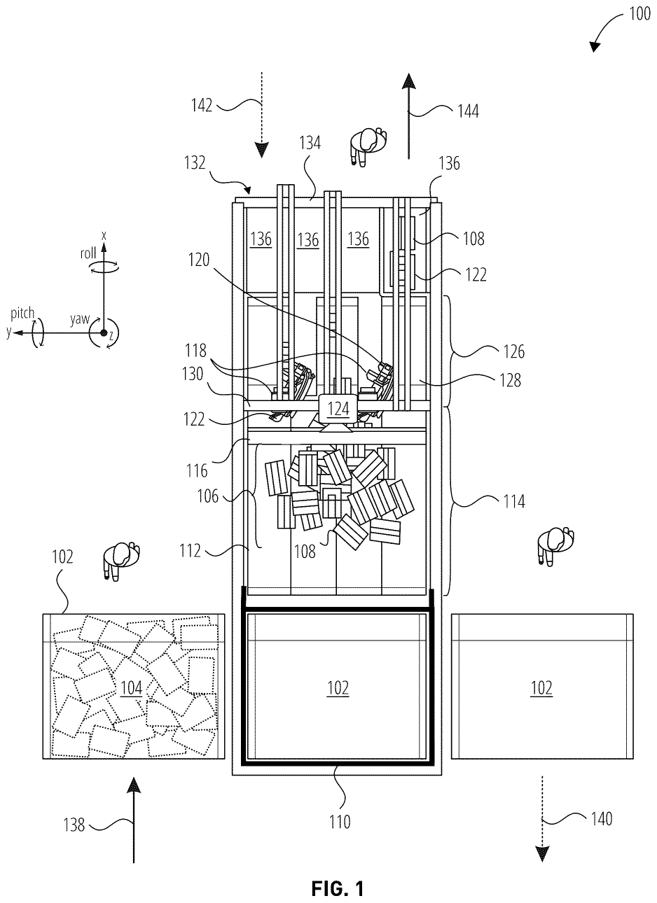

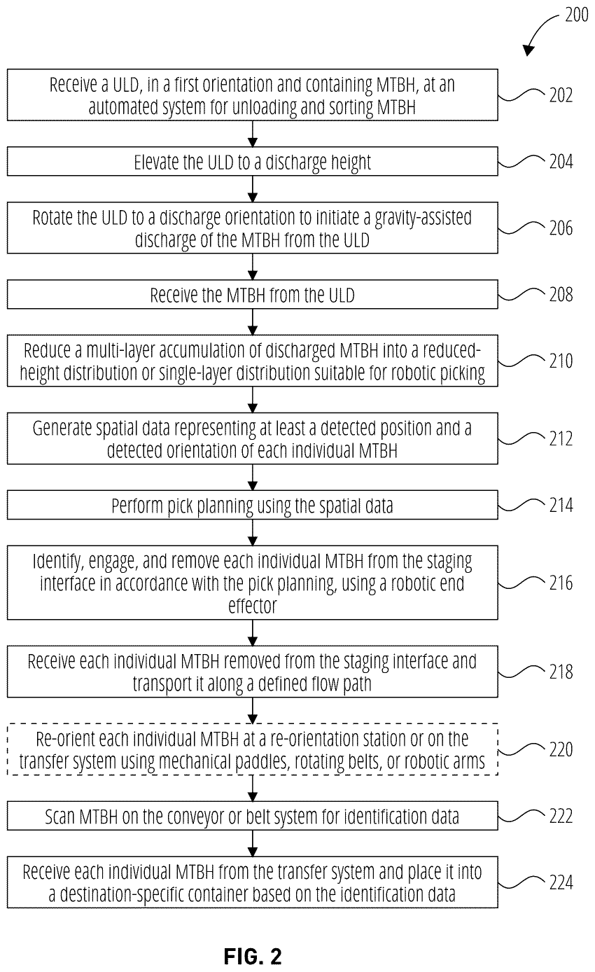

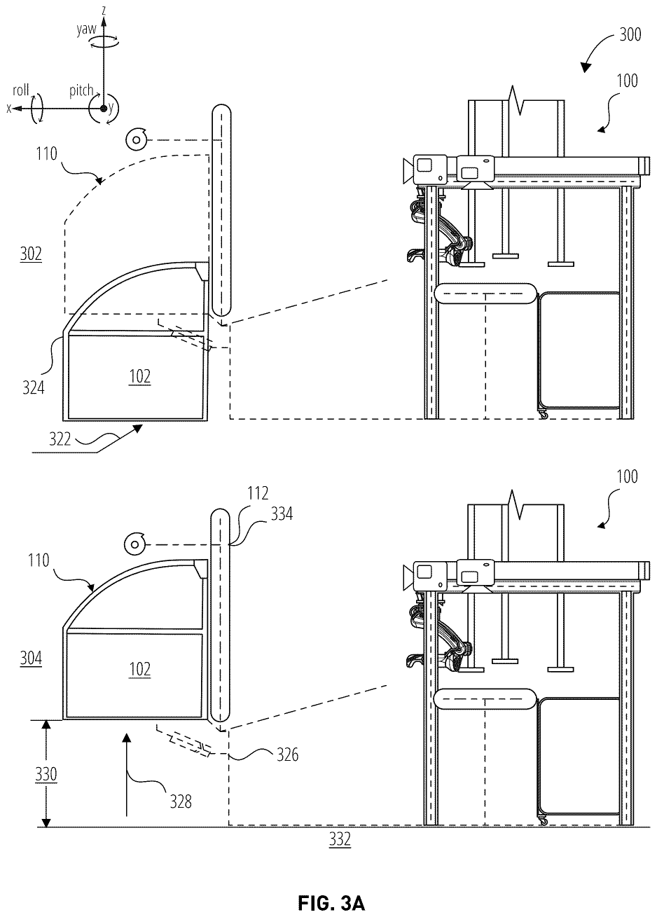

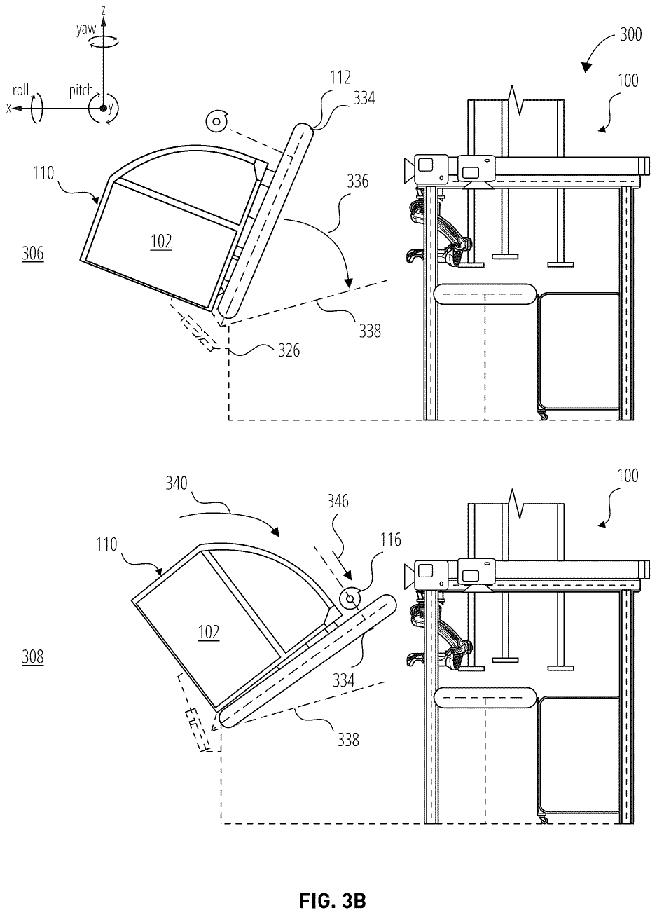

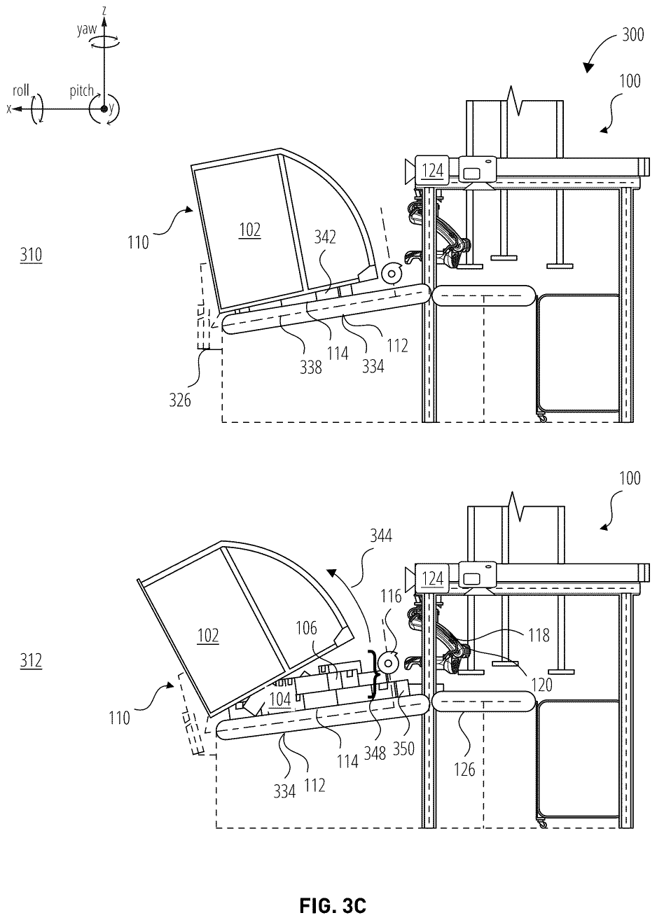

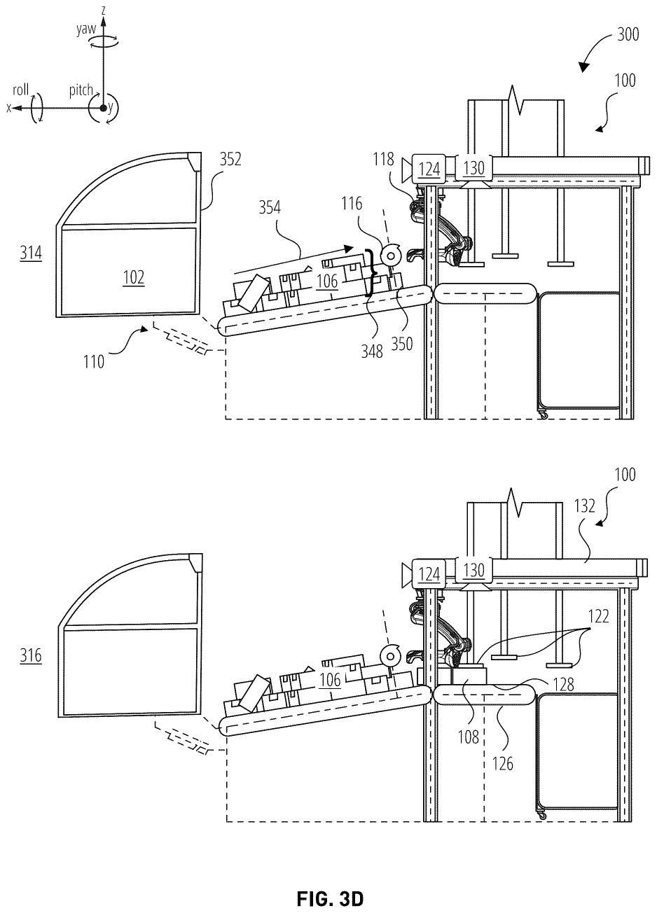

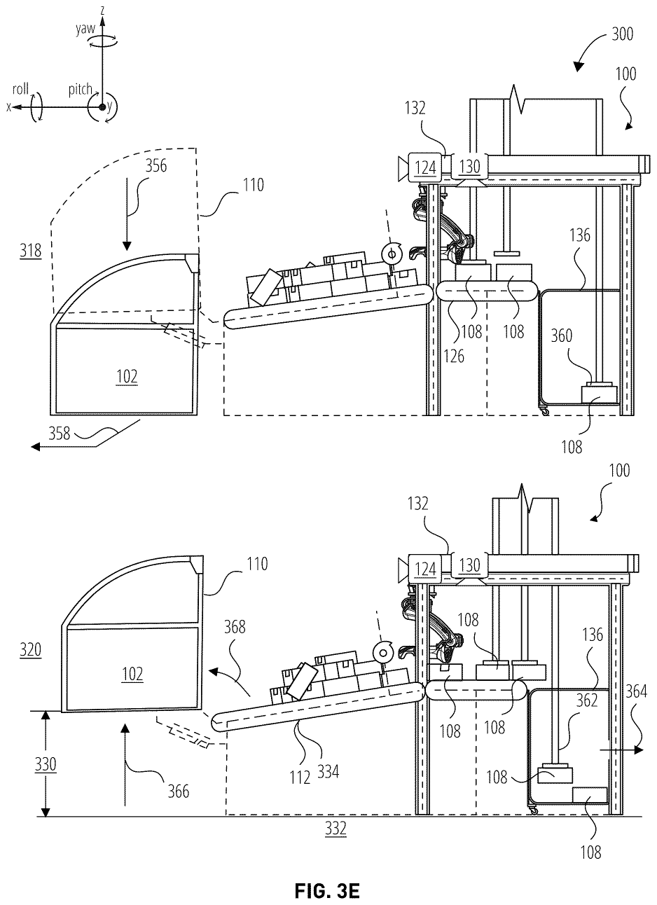

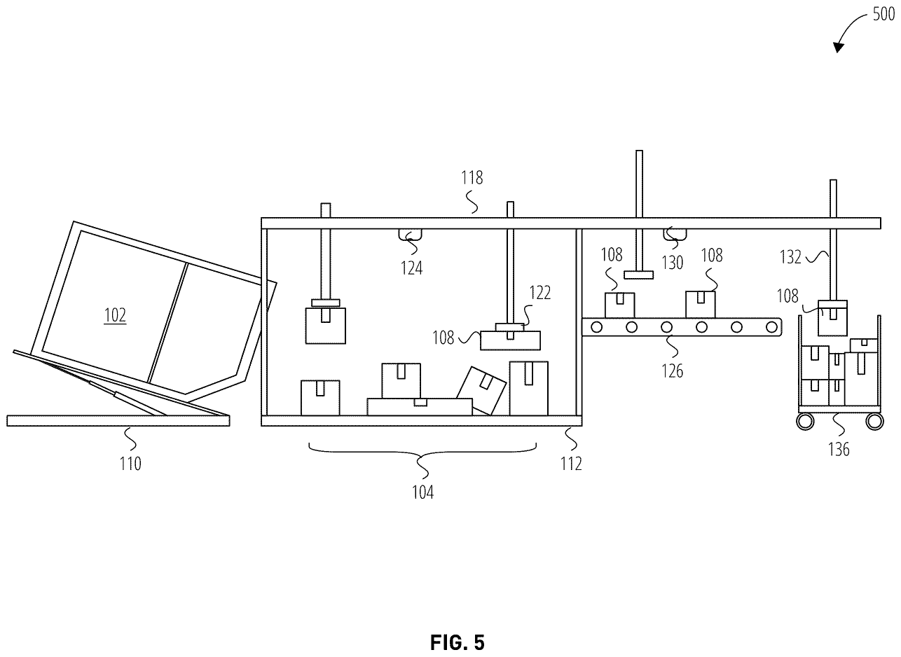

The present disclosure provides an automated system and method for high-throughput unloading and sorting of material to be handled (MTBH), such as boxes, packages, and parcels, from Unit Load Devices (ULDs) and handling individual MTBH through an integrated combination of mechanical automation, robotic manipulation, and vision-based identification. The disclosed solution comprises a system that supports robotic unloading of ULDs by converting a confined-space problem into an open-access picking problem via controlled tilting and staging. The high level automated ULD unloading system architecture is illustrated in FIGS. 1 and 5. A routine 200 flow of operations within the system is depicted in FIG. 2. An exemplary system performing an automated unloading and sorting routine such as the routine 200 of FIG. 2 is illustrated in FIGS. 3A-3E.

Recognizing that direct robotic unloading from within a ULD is impractical due to confined space and payload characteristics, the disclosed system uses a lifting and tilting mechanism to discharge the ULD's contents onto a designated platform area, such as a staging interface/pivoting conveyor. Once discharged, a primary robotic handling system including a multi-axis robot, such as Cartesian XYZ gantry robotic system, equipped with an intelligent perception system and an adaptable end effector, may be deployed over the platform area to rapidly pick individual parcels. In one embodiment, the MTBH or parcels are picked by a robotic arm having a robotic end effector configured to grip and lift MTBH. The robotic end effector may use a combination of suction force and mechanical force to grip and lift MTBH. In one embodiment, the primary robotic handling system may be implemented using one or more articulated robots having at least six degrees of freedom.

The system may identify each individual MTBH's position, orientation, and identification data using machine vision technologies. Picked MTBH may be transferred onto a conveyor or belt system, where they may be further scanned by a scanning station to extract for sorting attributes and identification data. The Scanning station may detect barcode, RFID tag, visual encoding, text, etc. Individual MTBH such as boxes or parcels may be re-oriented as needed during or after scanning to facilitate correct stacking or placement.

Following scanning and any necessary re-orientation, MTBH may be dynamically sorted and loaded onto destination-specific containers or pallets according to predefined logic. The system may be designed to achieve high throughput rates exceeding 1,000 parcels per hour, within a comparatively small footprint relative to conventional unloading and sortation systems. The automated system may be configured with scalable architectures to support multiple simultaneous unloading operations. By decoupling the unloading and sorting functions, and by moving the MTBH to an open-access platform prior to robotic handling, the disclosed system supports greater speed, flexibility, and robustness compared to direct robotic unloading from within the ULD itself.

Throughout the operation, a centralized supervisory control system may manage overall system coordination. The controller may monitor articulated robot positioning, gantry traffic, conveyor status, scanner performance, cart fill levels, ULD and cart locations, etc. It may dynamically adjust robotic picking sequences, conveyor speeds, and ULD and cart routing paths to maximize throughput and minimize downtime. Error handling routines may be incorporated to manage missed picks, double reads, or dropped parcels, redirecting affected parcels to reprocessing zones if necessary.

The system may be engineered to achieve parcel handling throughput exceeding 1,000 individual MTBH per hour per system, while maintaining high accuracy across scanning, orientation, and container loading operations. Its compact, modular, and flexible architecture supports easy adaptation to various ULD sizes, parcel mixes, and facility layouts, while taking up comparatively less facility floor space than conventional systems. Additionally, the design may support parallel deployment of multiple robotic systems, tilting stations, staging interfaces, and conveyor lines, allowing overall throughput to scale significantly as operational demands increase. The disclosed solution also significantly reduces manual labor dependency, increases operational safety, improves processing accuracy, and supports scalable deployment across logistics hubs of varying size and complexity.

In short, the disclosed solution introduces a novel approach wherein the ULD is first positioned onto a tilting mechanism. Through controlled tilting and mechanical assistance, the payload of parcels or packages is transferred from the confined ULD space onto a designated unloading platform. From this staging area, a gantry-style XYZ robotic handling system, in conjunction with advanced vision sensing and control algorithms, performs rapid picking, identification, scanning, re-orientation, and sorting of individual items. Packages are then conveyed via an integrated belt system to downstream processing, including destination-specific container palletization.

The disclosed system architecture supports the achievement of high throughput rates (targeting 1,000+ cartons per hour), while accommodating the irregularities in package geometries, orientations, and sizes typically encountered in ULD cargo loads. The disclosed solution thus addresses a major operational bottleneck in modern logistics facilities, improving safety, labor efficiency, and processing consistency.

FIG. 1 illustrates an automated ULD unloading system 100 in accordance with one embodiment. The automated ULD unloading system 100 is shown handling ULDs 102, MTBH in the ULD 104, discharged MTBH 106, and individual MTBH 108. The automated ULD unloading system 100 may comprise a lifting and tilting mechanism 110, a staging interface 112, a singulation mechanism 116, a primary robotic handling system 118 including an articulated robot with at least six degree of freedom 120 having a robotic end effector 122, a perception system 124, a transfer system 126, a scanning station 130, and a downstream sorting and loading system 132 including a multi-axis gantry robotic system 134 that loads individual MTBH into destination-specific containers 136. ULDs 102 and destination-specific containers 136 may be transferred to and from the automated ULD unloading system 100 as indicated by arrows showing the flow of full ULDs 138, the flow of empty ULDs 140, the flow of empty carts 142, and the flow of loaded carts 144.

The lifting and tilting mechanism 110 may be configured to receive a ULD 102 along with MTBH in the ULD 104, lift the ULD 102 to a discharge height, and tilt the ULD to a designated angle to discharge the MTBH in the ULD 104 onto a staging interface 112. The lifting and tilting mechanism may comprise a motorized frame with adjustable tilt angles to control a discharge flow rate of the MTBH from the ULD. The adjustable tilt angles may range from approximately 15 degrees to 45 degrees.

The staging interface 112 may be configured to temporarily hold discharged MTBH 106 from the ULD 102. The staging interface 112 may be or comprise a pivoting conveyor configured to abut the ULD 102 and pivot in coordination with the ULD 102 during a lifting and tilting operation to prevent the MTBH in the ULD 104 from falling out and sustaining damage prior to reaching the discharge height. The singulating roller may be positioned near the staging interface. Discharged MTBH 106 may come to rest on the staging interface 112 with individual MTBH piled and stacked on top of each other, many parcels deep. The singulating roller may be configured to flatten the mass of discharged MTBH to create a single layer of the discharged MTBH no more than one individual MTBH deep.

The primary robotic handling system 118 comprising at least one multi-axis robot may be positioned over the staging interface 112. A robotic end effector 122 may be coupled to the primary robotic handling system 118, allowing it to grip and lift individual MTBH 108. In one embodiment, two articulated robots with at least six degrees of freedom 120 may be included as the multi-axis robots of the primary robotic handling system 118. In one embodiment, the at least one multi-axis robot may comprise a multi-axis gantry robotic system designated for handling a single layer of the discharged MTBH 106. The multi-axis robot such as the articulated robot with at least six degree of freedom 120 or a multi-axis gantry robotic system may be configured to handle an unstructured MTBH arrangement on the staging interface 112.

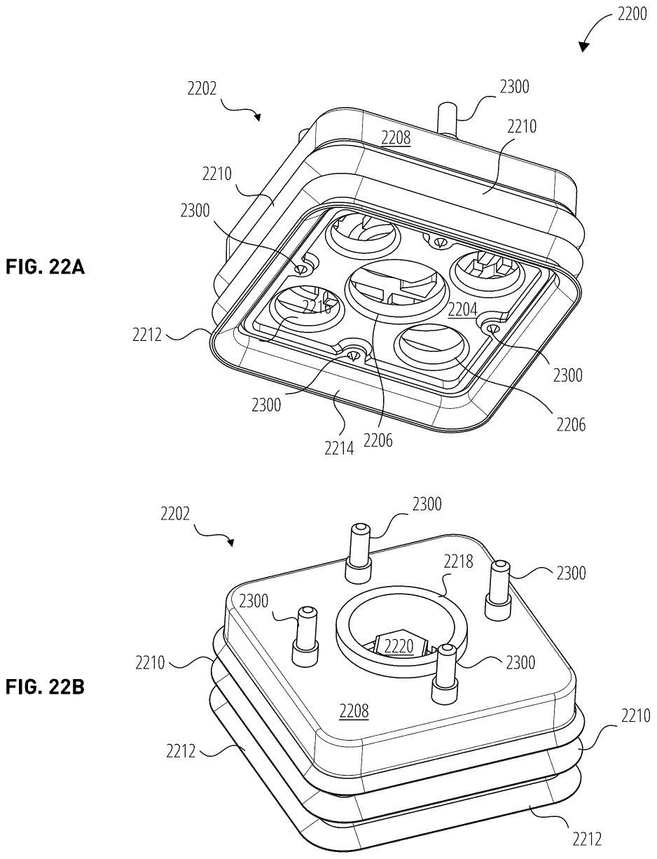

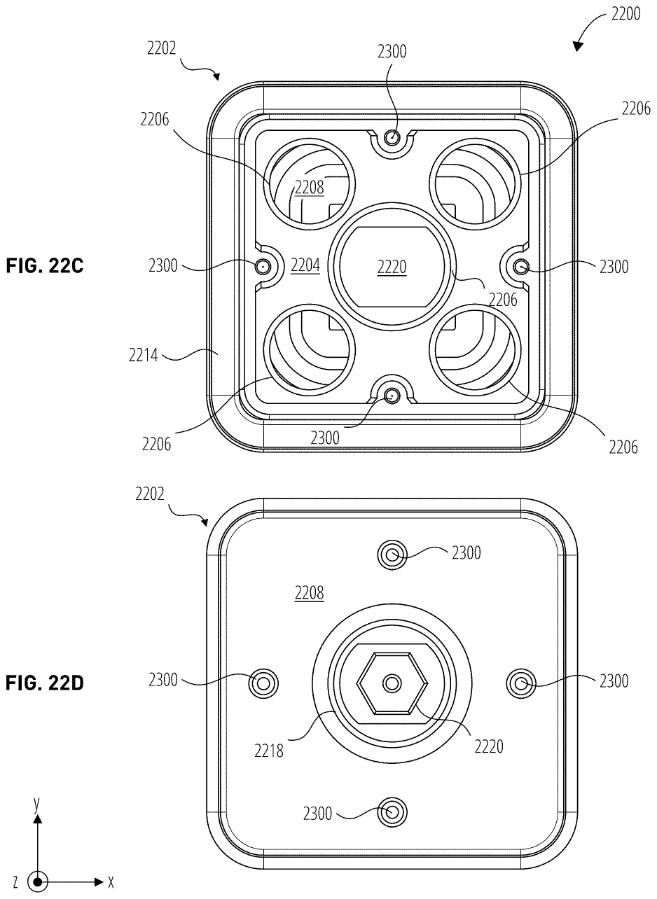

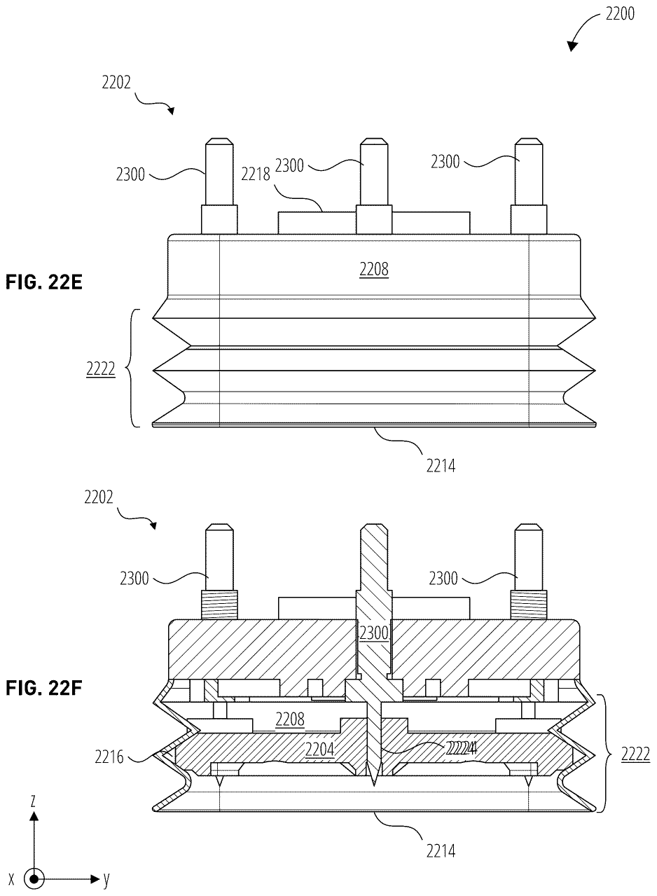

The robotic end effector 122 may utilizes a hybrid design combining a suction mechanism and a mechanical support mechanism. The robotic end effector includes a suction gripping apparatus. The suction gripping apparatus may comprising a suction gripping unit having a plurality of guiding support pins, a contact surface reinforcement sliding plate comprising at least one plate orifice, the contact surface reinforcement sliding plate may be configured to receive the plurality of guiding support pins and to provide reinforcement to the suction gripping unit during an action of suction, a suction chamber configured to receive the plurality of guiding support pins and the contact surface reinforcement sliding plate, the suction chamber comprising at least one side wall including a contacting edge, a contact surface at the contacting edge, the contact surface configured to apply a suction force to a pickable object, and an inner groove, integrated into the at least one side wall above the contact surface, the inner groove configured to accept the contact surface reinforcement sliding plate. The at least one plate orifice may be in fluid communication with the suction chamber, and a suction port may be in fluid communication with the suction chamber and configured to interface with a vacuum suction system. An exemplary gripping end effector 2400 and suction gripping apparatus 2200 are described in greater detail with respect to FIGS. 22A-31B

The perception system 124 may be configured to detect a location, an orientation, and identification data for each individual MTBH 108 among the discharged MTBH 106 situated on the staging interface 112. Identification data may include text, barcodes, or other forms of visual encoding. The perception system 124 may include red/blue/green (RGB) cameras, depth sensors, and light detection and ranging (LIDAR) sensors.

The transfer system 126 may be configured to receive each individual MTBH 108 from the primary robotic handling system 118. The primary robotic handling system 118 may position each individual MTBH 108 for transfer along a defined flow path 128. A scanning station 130 may be positioned along the transfer system 126 and may be configured to extract identification data for each individual MTBH 108. In one embodiment, a re-orientation station may be positioned along the transfer system 126. The re-orientation station may be configured to adjust the orientation of each individual MTBH 108 prior to a container loading operation. The re-orientation station utilizes at least one of mechanical paddles, rotating belts, and robotic arms to adjust the orientation of each individual MTBH.

The downstream sorting and loading system 132 may be configured to dynamically sort and load the discharged MTBH 106 into destination-specific containers 136 based on the extracted identification data determined by the scanning station 130. In one embodiment, the downstream sorting and loading system 132 may use a multi-axis gantry robotic system to handle structured palletization of the individual MTBH into the destination-specific containers 136.

For the purposes of this disclosure, an unstructured MTBH arrangement is an arrangement in which individual MTBH are randomly positioned and oriented, faces suitable for picking are not pre-aligned, MTBH may be overlapping, stacked at uneven heights, or partially occluded, no predefined grid, rows, or predictable placement pattern of MTBH is discernable. Further, an unstructured MTBH arrangement may include MTBH intended for storage in or transport to different locations within a facility, different facilities, etc., and may thus be in a condition unsuitable for efficient sortation into destination-specific containers. An unstructured MTBH arrangement may be one where the robotic system may not assume order, alignment, repeatability, or other attributes by which MTBH may be prioritized, ordered, or filtered. Thus the robotic handling system may perceive and reason about each item individually.

For the purposes of this disclosure, structured palletization or other structured arrangements of MTBH are arrangements in which MTBH are placed in known, repeatable positions, orientations are uniform or constrained, spatial relationships follow a defined pattern or logic, and/or MTBH are sorted based on their intended destinations and may be readily loaded into destination-specific containers.

FIG. 2 illustrates an example routine 200 for performing the disclosed method for automated unloading and sorting of MTBH from a ULD. Although the example routine 200 depicts a particular sequence of operations, the sequence may be altered without departing from the scope of the present disclosure. For example, some of the operations depicted may be performed in parallel or in a different sequence that does not materially affect the function of the routine 200. In other examples, different components of an example device or system that implements the routine 200 may perform functions at substantially the same time or in a specific sequence.

According to some examples, the method includes receiving a ULD, in a first orientation and containing MTBH, at an automated system for unloading and sorting MTBH at block 202. For example, the lifting and tilting mechanism 110 illustrated in FIG. 1 may receive a ULD, in a first orientation and containing MTBH, at an automated system for unloading and sorting MTBH. The ULD containing a payload of MTBH such as packed parcels may be positioned onto a specially designed lifting and tilting mechanism either robotically or manually.

According to some examples, the method includes elevating the ULD to a discharge height at block 204. For example, the lifting and tilting mechanism 110 illustrated in FIG. 1 may elevate the ULD to a discharge height. The lifting and tilting mechanism may comprise a motorized frame with adjustable tilt angles and discharge heights. The discharge height may allow MTBH to be raised to a suitable height to facilitate and streamline downstream container loading operations without reliance on long inclined conveyer systems, allowing the same material handling capabilities to be accommodated in a smaller footprint.

According to some examples, the method includes rotating the ULD to a discharge orientation to initiate a gravity-assisted discharge of the MTBH from the ULD at block 206. For example, the lifting and tilting mechanism 110 illustrated in FIG. 1 may rotate the ULD to a discharge orientation to initiate a gravity-assisted discharge of the MTBH from the ULD. In one embodiment, a discharge flow rate of the MTBH from the ULD may be controlled by adjusting the designated angle of the lifting and tilting mechanism to a range between approximately 15 degrees and 45 degrees. The tilt degree may be selected to accommodate attributes of the load distribution and MTBH type. This tilt may be accomplished by pivoting and rotating the ULD with pitch rotation. Safety restraints or side guides may be included to ensure the ULD remains secure during tilting. Upon activation, the lifting and tilting mechanism may incrementally tip the ULD to a controlled angle, allowing gravity-assisted discharge of the MTBH. The tilting process may be adjusted to accommodate different MTBH fragility levels, ensuring that parcels of particular fragility are deposited gently to prevent damage.

According to some examples, the method includes receiving the MTBH from the ULD at block 208. For example, the staging interface 112 illustrated in FIG. 1 may receive the MTBH from the ULD. In one embodiment, the staging interface may comprise a pivoting conveyor. The pivoting conveyor may be configured to abut the ULD and pivot in coordination with the ULD during a lifting and tilting operation to prevent the MTBH in the ULD from falling out and sustaining damage prior to reaching the discharge height.

According to some examples, the method includes reducing a multi-layer accumulation of discharged MTBH into a reduced-height distribution or single-layer distribution suitable for robotic picking at block 210. For example, the singulation mechanism 116 illustrated in FIG. 1 may reduce a multi-layer accumulation of discharged MTBH into a reduced-height distribution or single-layer distribution suitable for robotic picking.

According to some examples, the method includes generating spatial data representing at least a detected position and a detected orientation of each individual MTBH at block 212. For example, the perception system 124 illustrated in FIG. 1 may generate spatial data representing at least a detected position and a detected orientation of each individual MTBH.

According to some examples, the method includes performing pick planning using the spatial data at block 214. For example, the primary robotic handling system 118 illustrated in FIG. 1 may perform pick planning using the spatial data.

According to some examples, the method includes identifying, engage, and remove each individual MTBH from the staging interface in accordance with the pick planning, using a robotic end effector at block 216. For example, the primary robotic handling system 118 illustrated in FIG. 1 may identify, engage, and remove each individual MTBH from the staging interface in accordance with the pick planning, using a robotic end effector. In one embodiment, the primary robotic handling system may use industrial articulated robots or robotic arms having six or more degrees of freedom, configured to handle an unstructured MTBH arrangement, such as the robotic unloading system described below. In one embodiment, two articulated robots are used. The primary robotic handling system may be a multi-axis gantry robotic system in one embodiment. The primary robotic handling system may be equipped with a robotic end effector. the robotic end effector may utilize a hybrid design combining a suction mechanism and a mechanical support mechanism.

According to some examples, the method includes receiving each individual MTBH removed from the staging interface at block 218. For example, the transfer system 126 illustrated in FIG. 1 may receive each individual MTBH removed from the staging interface.

According to some examples, the method includes re-orient each individual MTBH at a re-orientation station or on the transfer system using mechanical paddles, rotating belts, or robotic arms at block 220.

According to some examples, the method includes scanning MTBH on the conveyor or belt system for identification data at block 222. For example, the scanning station 130 illustrated in FIG. 1 may scan MTBH on the conveyor or belt system for identification data. The identification data may include destination identifiers associated with particular destination-specific containers. In this manner, the scanning station may inform the downstream sorting and loading system as to how the individual MTBH is to be aggregated into structured palletization configurations.

According to some examples, the method includes receiving each individual MTBH from the transfer system and place it into a destination-specific container based on the identification data at block 224. For example, the downstream sorting and loading system 132 illustrated in FIG. 1 may receive each individual MTBH from the transfer system and place it into a destination-specific container based on the identification data. The downstream sorting and loading system may in one embodiment be a multi-axis gantry robotic system. Such a gantry system may be able to move individual MTBH in three dimensions (along the x, y, and z axes). In one embodiment, the end effectors of the multi-axis gantry robotic system may be further capable of moving each individual MTBH with yaw, roll, and pitch rotation for highly precise positioning within the carts.

In this manner, the multi-axis gantry robotic system of the downstream sorting and loading system may sort and load the discharged MTBH dynamically into the destination-specific containers by performing structured palletization of the MTBH. Containers such as carts, bins, or pallets, may be moved manually or may be positioned for loading by the downstream sorting and loading system and taken to various destinations after loading by AMRs.

FIG. 3A illustrates a ULD unloading process 300 in accordance with one embodiment. The block diagram illustrates the sequential operations of ULD unloading and MTBH picking, scanning, and cart loading. In this manner, an exemplary automated ULD unloading system 100 such as is disclosed herein may perform an exemplary routine 200, thereby operating in accordance with the disclosed method.

In step 302 the ULD 102 containing MTBH is manually or automatically transported 322 to an automated ULD unloading system 100. The ULD 102 is received by the lifting and tilting mechanism 110. The ULD 102 may be received and held within the lifting and tilting mechanism 110 in a first orientation 324

At step 304, the motorized frame 326 of the lifting and tilting mechanism 110 elevates 328 the ULD 102 to a discharge height 330 above ground level 332. In the illustrated embodiment, this operation also brings a pivoting conveyor 334 of the staging interface 112 into abutment with the ULD 102. As used herein, “abutment” indicates that two structures having planar facets are brought into proximity such that their planar facets are parallel and separated by a distance small enough to prevent passage of objects included in MTBH. In this manner, MTBH within the ULD 102 may be prevented from premature discharge from the ULD 102 and incurring resulting damage during the lifting and tilting operation.

In step 306, the motorized frame 326 of the lifting and tilting mechanism 110 supports the ULD 102 and the pivoting conveyor 334 of the staging interface 112 as they rotate 336 together in a coordinated manner to reach the discharge orientation 338 within a range of adjustable tilt angles. As the ULD 102 and pivoting conveyor 334 continue to rotate 340 toward the discharge orientation 338 in step 308, the singulation mechanism 116 may be repositioned 346 toward the top surface of the pivoting conveyor 334.

At step 310, the motorized frame 326 of the lifting and tilting mechanism 110 has brought the ULD 102 and pivoting conveyor 334 into alignment with the discharge orientation 338 as shown. In step 312, the lifting and tilting mechanism 110 begins to tilt 344 the ULD 102 away from the pivoting conveyor 334 of the staging interface 112, discharging the MTBH in the ULD 104 onto the staging interface 112 in an open-access picking region 114 via gravity-assisted discharge 342. The pivoting conveyor 334 of the staging interface 112 and the ULD 102 may thus be brought into abutment and tilted in a coordinated manner, and may also be independently tilted from the discharge orientation 338 to a not tilted position.

As the staging interface 112 begins to convey the discharged MTBH 106 to the articulated robot with at least six degree of freedom 120 of the primary robotic handling system 118, the singulation mechanism 116 levels the multi-layer accumulation 348 of discharged MTBH 106 into a reduced-height distribution/single-layer distribution 350. The articulated robot with at least six degree of freedom 120 may assist in forming the reduced-height distribution/single-layer distribution 350 in one embodiment, or may act in place of the singulation mechanism 116. The articulated robot with at least six degree of freedom 120 may receive control signals based on data from the perception system 124, including spatial data representing a detected position and detected orientation. The articulated robot with at least six degree of freedom 120 or other element of a primary robotic handling system 118 may thus be directed by these control signals to perform pick planning, and then identify, engage, and remove individual MTBH from the staging interface 112, depositing it onto the transfer system 126.

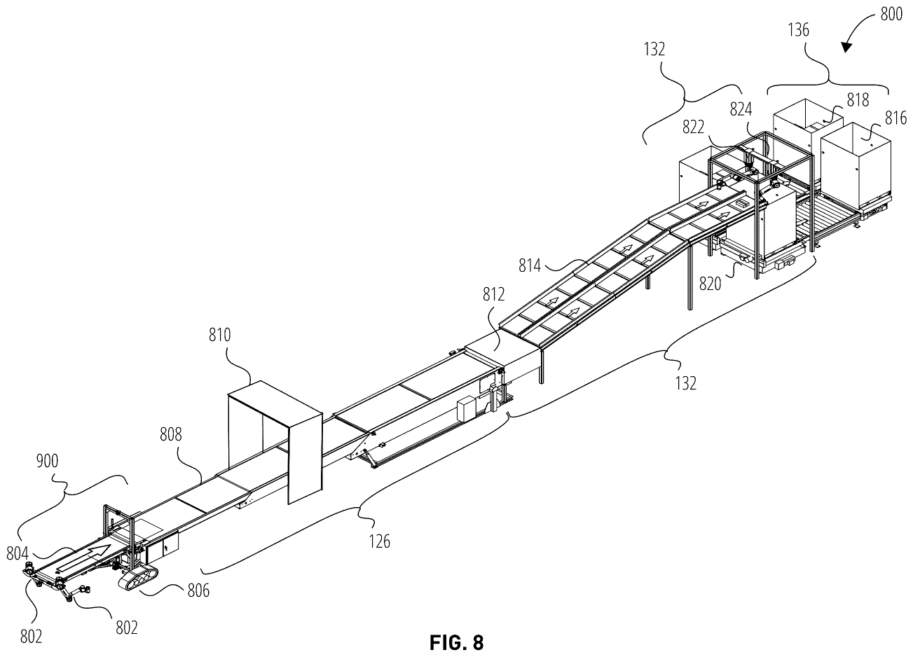

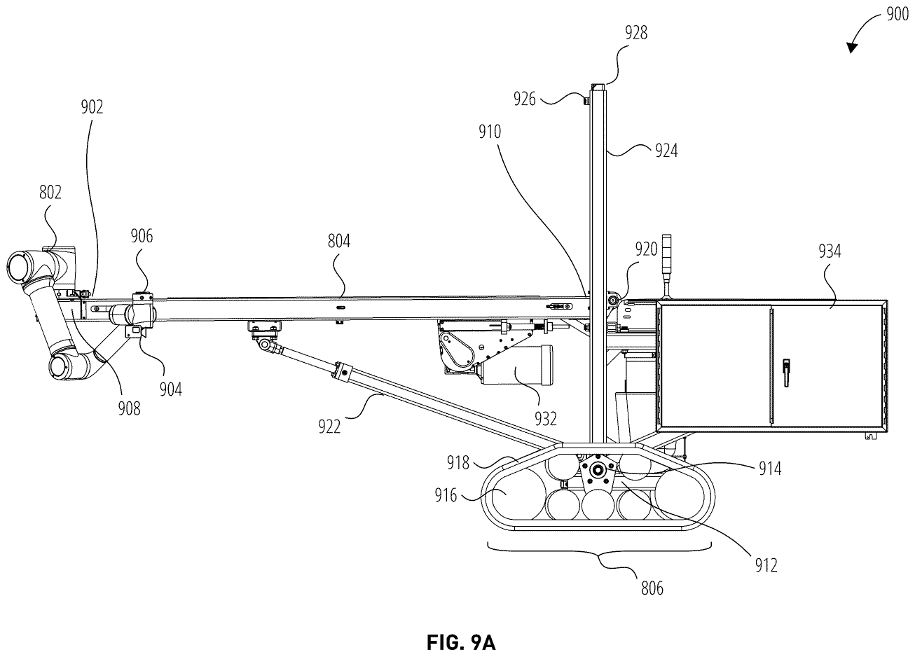

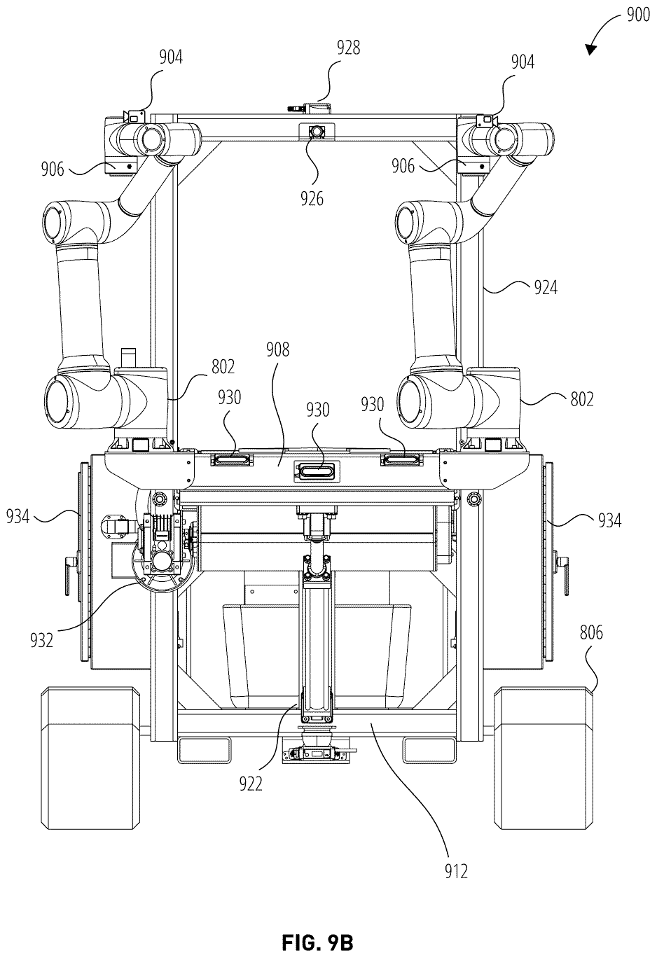

The abilities of an articulated robot with at least six degree of freedom 120 to pick and place individual MTBH 108, and the direction of control systems in coordinating this action based on data from perception system sensor components are described in additional detail below with regard to the articulated robot 802 of the robotic unloading system 800 and robotic handling system 900 of FIGS. 8-9B.

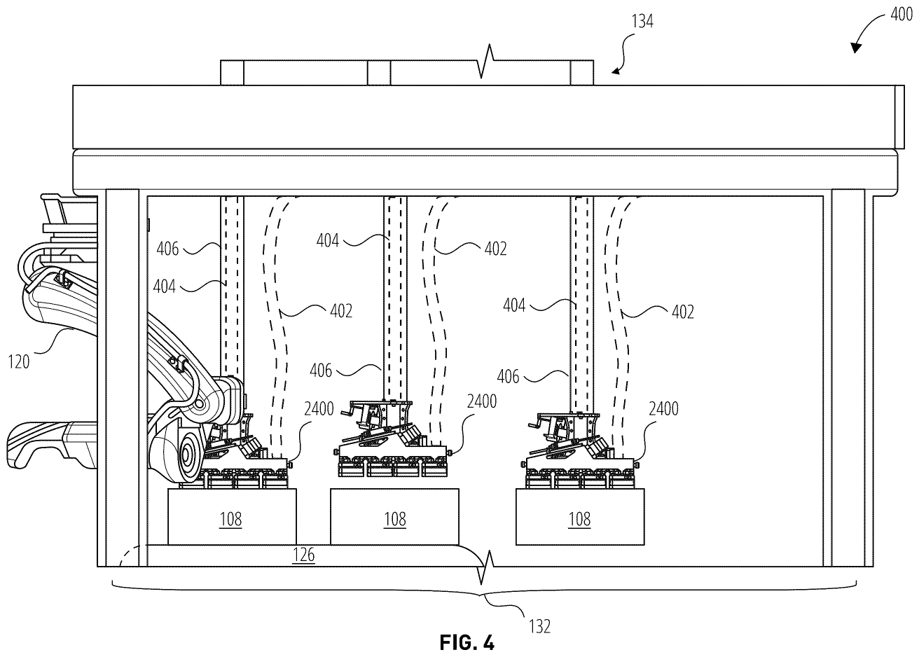

In step 314, as the discharged MTBH 106 continues to move 354 toward the primary robotic handling system 118 and the singulation mechanism 116 continues to configure it in a reduced-height distribution/single-layer distribution 350, the lifting and tilting mechanism 110 moves the ULD 102 into a lifted and not tilted position 352. In step 316 the primary robotic handling system 118 moves individual MTBH 108 onto the transfer system 126. The primary robotic handling system 118 may position each individual MTBH 108 along a defined flow path 128 in the y axis such that the three robotic end effectors 122 of the downstream sorting and loading systems 132 shown, each of which may operate across a dedicated range of space in the y-dimension, may easily pick individual MTBH 108 sorted with respect to data provided by the scanning station 130. A similar downstream sorting and loading systems 132 including a multi-axis gantry robotic system with gripping end effectors 400 is illustrated in FIG. 4.

At step 318, the lifting and tilting mechanism 110 lowers 356 the ULD 102 back to the ground. The ULD 102 is automatically or manually transported 358 away from the automated ULD unloading system 100. The downstream sorting and loading system 132 may places 360 an individual MTBH 108 into a destination-specific container 136.

At step 320, the downstream sorting and loading system 132 may continue to place 362 individual MTBH 108 into destination-specific containers 136. As destination-specific containers 136 receive their completed loads, they are automatically or manually transported 364 to their designated destinations. The lifting and tilting mechanism 110 lifts 366 a new ULD 102 loaded with MTBH from ground level 332 to the discharge height 330. When the staging interface 112 has been cleared of discharged MTBH 106 by the primary robotic handling system 118, the pivoting conveyor 334 may pivot 368 back into abutment with the ULD 102 as show in step 304 and unloading and sorting may continue.

FIG. 4 illustrates a multi-axis gantry robotic system with gripping end effectors 400 in accordance with one embodiment. The multi-axis gantry robotic system with gripping end effectors 400 may be used to implement the downstream sorting and loading system 132 described with respect to FIG. FIGS. 1 and 5. The multi-axis gantry robotic system with gripping end effectors 400 may comprise a multi-axis gantry robotic system 134 having three gripping end effectors 2400 configured and positioned to grip and lift individual MTBH 108 from the transfer system 126. The gripping end effector 2400 may operate using both suction force and mechanical force to securely grip MTBH. These elements are described in greater detail below.

In one embodiment, suction forces for each gripping end effector 2400 are supplied using an external suction hose 402 running from a suction pressure source to a gripping end effector 2400 and in fluid communication with suction gripping apparatus included in the gripping end effector 2400. In one embodiment, the end effector supports 406 that allow the gripping end effector 2400 to traverse their zones of operation in three dimensions may include internal suction conduits 404 in order to prevent the damage exposed hoses may incur in a rapidly moving system.

FIG. 5 illustrates an automated ULD unloading system 500 in accordance with one embodiment. The automated ULD unloading system 500 may comprise a lifting and tilting mechanism 110, a ULD 102, MTBH in the ULD 104 including individual MTBH 108, a staging interface 112, a primary robotic handling system 118, a perception system 124, a robotic end effector 122, a transfer system 126, a scanning station 130, a downstream sorting and loading system 132, and a destination-specific container 136.

The lifting and tilting mechanism 110 may be configured to receive, lift, and tilt the ULD 102 holding material to be handled (MTBH in the ULD 104), wherein lifting and tilting the ULD discharges the MTBH in the ULD 104 from the ULD 102. A staging interface 112 may be configured to accept the MTBH in the ULD 104 discharged from the ULD 102. A robotic handling system may be configured above the staging interface 112 to handle the MTBH in the ULD 104.

In one embodiment, the robotic handling system may be a gantry robotic system. In one embodiment, the robotic handling system may be an industrial robot capable of motion with six or more degrees of freedom (DOF). A perception system 124 may be configured to detect a location, an orientation, and identification data of an individual MTBH 108 on the staging interface 112.

A robotic end effector 122 attached to the primary robotic handling system 118 may be capable of gripping and lifting the individual MTBH 108 from the staging interface 112. A transfer system 126 may be configured to receive the individual MTBH 108 from the primary robotic handling system 118. A scanning station 130 along the transfer system 126 may be configured to scan the identification data of the individual MTBH 108. A downstream sorting and loading system 132 may be configured to sort and load the individual MTBH 108 into a destination-specific container 136 based on the identification data.

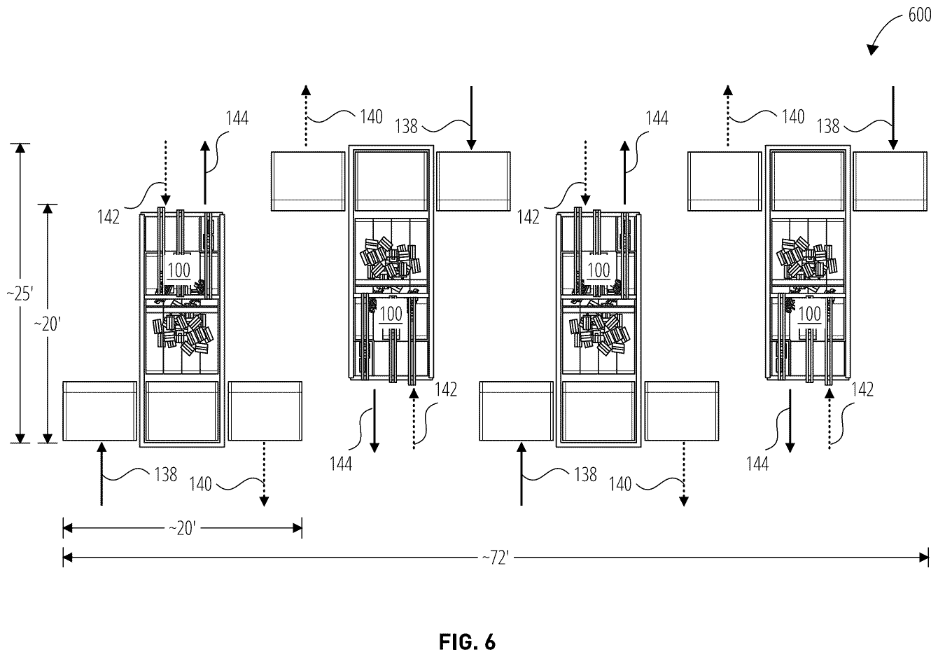

FIG. 6 illustrates an automated ULD unloading system array 600 in accordance with one embodiment. The capabilities provided by the lifting and tilting mechanism 110 of the automated ULD unloading system 100 allow a much smaller footprint to support the operational capabilities of two articulated robots with at least six degrees of freedom 120 and one multi-axis gantry robotic system 134 as previously described. The configuration of the automated ULD unloading system 100 also allows for streamlined transport of ULDs and carts to and from adjacent automated ULD unloading systems 100 with minimal interruption in the flow of full ULDs 138 and the flow of empty carts 142 to each automated ULD unloading system 100 and the flow of empty ULDs 140 and flow of loaded carts 144 away from the automated ULD unloading system 100 when MTBH transfer is complete.

In one embodiment, each automated ULD unloading system 100 may be expected to take up approximately 400 square feet of facility floor space as shown. Multiple adjacent automated ULD unloading systems 100 may be tiled as shown and still provide adequate safety clearances for workers and equipment moving among the automated ULD unloading systems 100. In such a configuration, four automated ULD unloading systems 100 may be expected to take up approximately 1,800 square feet of space within a facility. This configuration and these dimensions are exemplary, and are not intended to be limiting. One of ordinary skill in the art will appreciate that even more compact configurations may be possible. In this manner, the operational capabilities of eight articulated robots with at least six degree of freedom and four multi-axis gantry robotic systems may be supported within a footprint of 1,800 square feet.

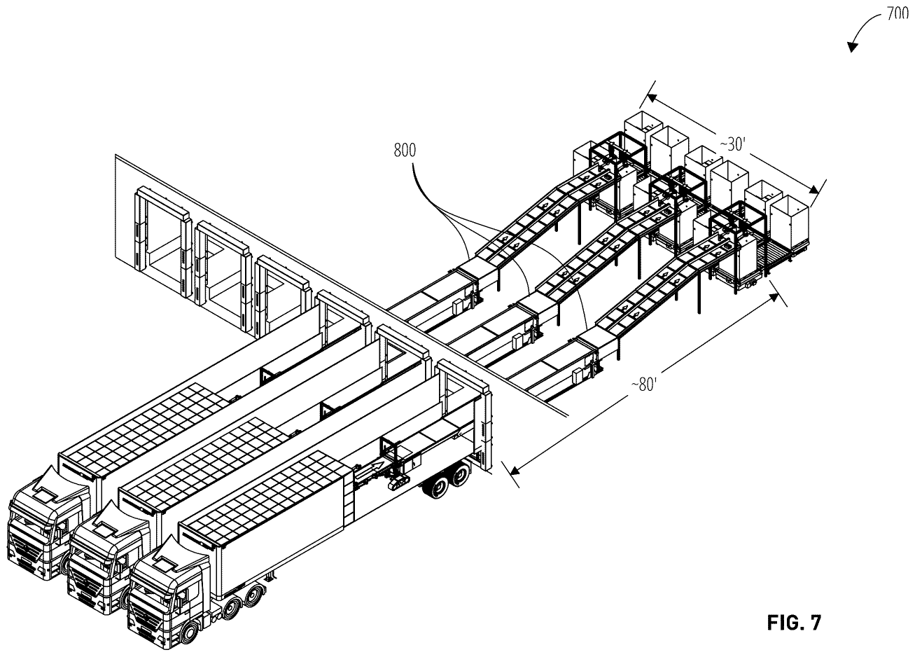

FIG. 7 illustrates a robotic unloading system array 700 in accordance with one embodiment. The robotic unloading system array 700 includes three robotic unloading systems 800 as described with respect to FIG. 8 below. As may be seen therein, each robotic unloading system 800 may include two articulated robots with at least six degrees of freedom and a gantry-supported container loading robot 822. In one embodiment, this robotic unloading system array 700 may be expected to take up 2,400 square feet of facility floorspace, as shown here, such that the operational capabilities of six articulated robots with at least six degrees of freedom and three container loading robots 822 may be supported within a footprint of 2,400.

One may compare the unloading and sorting capabilities supported by the robotic unloading system array 700 with those of the automated ULD unloading system array 600 described above. In representative embodiments, one of ordinary skill in the art will readily appreciate that the automated ULD unloading system array 600 may perform 33% more work while taking up 75% of the floorspace within a material handling facility. Thus, even with conservative estimates and configurations, the automated ULD unloading system 100 represents a significant technical improvement over other high-performing systems.

FIG. 8 illustrates a perspective view of a robotic unloading system 800 that may be used to accept MTBH deposited on the staging interface 112 by the lifting and tilting mechanism 110 onto a transfer system 126 using a primary robotic handling system 118, and from thence to a downstream sorting and loading system 132, according to various embodiments of the present disclosure. Aspects of exemplary operation and control of the robotic unloading system 800 are described in additional detail below with respect to FIGS. 9A-21. One of ordinary skill in the art will appreciate that, while the equipment illustrated herein differs in form from that shown from the automated ULD unloading systems 100 and automated ULD unloading system 500 introduced above, the functions performed and the perceptions, operations, and controls supporting them are analogous.

The robotic unloading system 800 may comprise a robotic handling system 900 including one or more articulated robots 802, a loading conveyor 804, a grounded base 806, and other elements described more fully with respect to FIG. 9A. The robotic unloading system 800 may further comprise a transfer system 126 including a telescoping transport conveyor 808, as well as a scanning station 810 in the form of a scanning tunnel configured above and around the telescoping transport conveyor 808. The robotic unloading system 800 may include a downstream sorting and loading system 132 including a sorting MHE 812, an incline MHE 814, and a downstream sorting and loading system 132 comprising at least one container loading robot 822 and a container loading robot support gantry 824 configured to load destination-specific containers 136. An empty cart 816, an at least partially stacked cart 818, and an AMR 820 are also shown.

This robotic unloading system 800 is utilized in systems and methods for automated truck unloading, automated palletization, and packing of trailers, containers, and the like. A high number of robotic DOF are used by a robotic handling system 900 with articulated robots 802 to grasp, manipulate, and transport packages from an unloading area to an attached loading conveyor 804, which has the ability to pivot, translate or rotate up and down. In this embodiment two separate articulated robots 802 are presented in a manner in which they operate near each other with overlapping kinematic reach volumes and may coordinate with each other via an optimized 12-DOF kinematic solver. The ability to move up and down allows the robotic platform to get closer to the fluid loaded packages and reduces the distance that the articulated robots 802 need to travel. This may increase the throughput of the system.

The loading conveyor 804 may transfer MTBH from the staging interface 112 introduced in FIG. 5 to the telescoping transport conveyor 808 in one embodiment. In one embodiment, the loading conveyor 804 may be configured with respect to the lifting and tilting mechanism 110 and the primary robotic handling system 118 in order to act as the staging interface 112.

In some cases, the transport conveyor may be flexible, but in most embodiments, the use of a fixed telescopic type conveyor for the telescoping transport conveyor 808 may support particular material handling characteristics related to the size of the MTBH that demand a continuous belt. The telescoping transport conveyor 808 may be a MaxReach telescoping conveyor or similar construction, and may be modified as needed to accommodate the robotic handling system 900. A scanning station 810 may be configured at a location along the telescoping transport conveyor 808. At the scanning station 810, visual sensors such as cameras, barcode scanners, etc., may provide a five- or six-sided scan of MTBH in the ULD 104 traveling along the telescoping transport conveyor 808. Information gathered in the scanning station 810 may be used for tracking of MTBH in the ULD 104 and sortation of MTBH in the ULD 104 at later stages of the robotic unloading system 800.

The robotic handling system 900 may be equipped with a high number of robotic DOF as well as various perception systems that allow the robotic DOF to identify MTBH in the ULD 104 as well as the constraint space in which the robotic handling system 900 may operate. The attached or fixed perception systems may be any combination of one-dimensional (1D), two-dimensional (2D), and three-dimensional (3D) perception systems. These perception systems may allow the robotic handling system 900 to determine where the packages are and in what orientation they rest, allowing robotic end-effectors to optimize the contact normal from which they may grip the packages, the picking rate, and the probability of a successful pick. The robotic handling system 900 may also provide six-sided perception of the packages, including the weight and instantaneous center of gravity of the packages, during MTBH manipulation or after placement into the system. These perception systems are typically very sensitive to noise and vibration, so the robotic handling system 900 may utilize a type of support or grounded base 806, such as tracks or wheels, that provides a wide footprint and low contact pressure so as to distribute the weight of the system. Grounded base 806 may include a pivot point, allowing the robotic handling system 900 to move in and out of the container while providing stability and support, even in the event that uneven or sloped terrain is encountered, which is not possible with traditional flexible and telescoping transport conveyors.

The flexible or fixed telescoping transport conveyor 808 may have at least one connection point to traditional material handling equipment (MHE) or may transfer to mobile material handling systems. In this embodiment, the system transfers to a type of sorting MHE 812 that allows for the singular flow of goods to be split into n-number of different lanes for sortation. In one embodiment the sorting MHE 812 may be 2-Way Sortation manufactured by Regal Rexnord, Cellmation, or Intralox. Such sorting MHE 812 may split from one supply lane to two or four sort lanes in continuous flow quite easily. This may allow for downstream palletization or cart loading to be optimized depending on the incoming materials that arrive at the material handling facility or may allow flow directly into a set of cross-docked MHE.

Where unloading to destination-specific containers 136 is intended, in one embodiment, a set of incline MHE 814 may allow the MTBH in the ULD 104 to be transferred from the lower height (“top of roller”) of the telescoping transport conveyor 808 to a level needed by the downstream sorting and loading system 132. An Interoll Incline Dual Conveyor may be used for this purpose. The incline MHE 814 may decouple the two subsystems and brings the MTBH in the ULD 104 to the correct location for cart loading. The downstream sorting and loading system 132 may bring the MTBH in the ULD 104 consistently to a known location in 3D space so that the speed of the downstream sorting and loading system 132 is optimized. In most systems on the market, the flow of materials is random and may need to employ additional computation to locate the packages. The downstream sorting and loading system 132 may use container loading robots 822 such as the Robotiq Palletizer System to place MTBH in the ULD 104 as it arrives at the top of the incline MHE 814. The container loading robots 822 may be supported by a container loading robot support gantry 824.

MTBH in the ULD 104 may be placed into a protective destination-specific container 136 such as empty cart 816 that allows for high-speed placement without concern that the packages will fall over, slip, or move. The destination-specific containers 136 may allow for automated transport, whether empty, partially loaded, or full, throughout the additional downstream systems of a material handling facility. Destination-specific containers 136 may be optimized for automatic flow of MHE, or may support the use of independent, agent-based AMR 820 material handling systems. AMRs 820 may bring destination-specific containers 136 directly into the downstream sorting and loading system 132 or may interface with MHE. A 2-DOF MHE may allow destination-specific containers 136 to flow in and transfer at a perpendicular vector to a loading area without rotation about the Z-axis.

An AMR 820 may interface with the fixed MHE (such as the 2-DOF MHE) and offload empty carts 816. The empty cart 816 may be the entry point of the cart loading flow, and the at least partially stacked cart 818 may be the exit point. The AMR 820 may bring an empty cart 816 to the downstream sorting and loading system 132, then may pick up an at least partially stacked cart 818 at the same or a different location. The MHE may be configured to support multiple different load and unload architectures and mappings depending on the flow of materials. The AMR 820 may navigate to any perimeter location to accept the transfer of and transport a destination-specific container 136. The AMR 820 may also transport pallets without sleeves, as well as pallet sleeves not assembled around pallets, MTBH too large to fit within a destination-specific container 136, and disassembled destination-specific container 136 components such as cart bases and cart side panels.

FIG. 9A illustrates a side elevation view of a robotic handling system 900 according to various embodiments of the present disclosure. FIG. 9B illustrates a front elevation view of the 900.

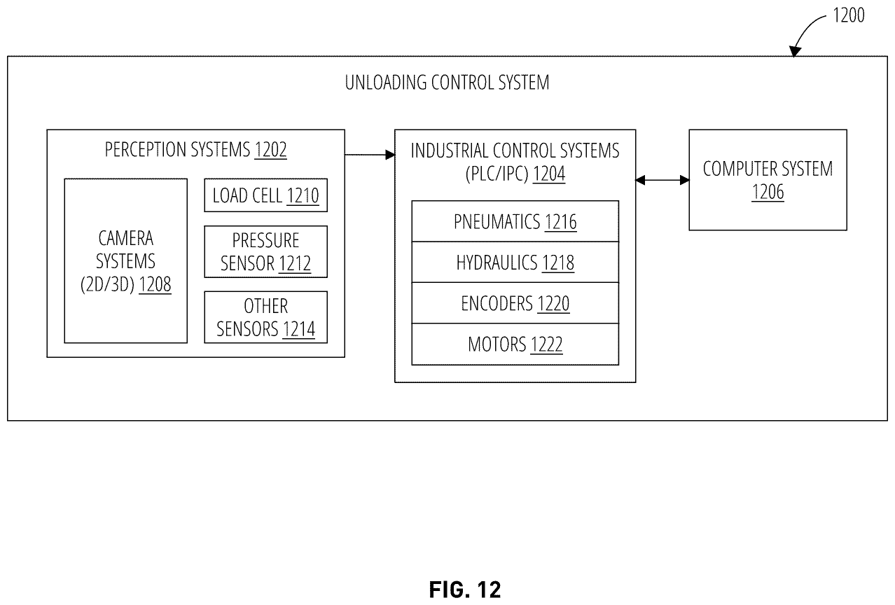

The robotic handling system 900 includes a high DOF robotic system, incorporating at least two articulated robots 802, each capable of at least six DOFs of motion. The articulated robots 802 may include robot joints that support their DOF of motion, allowing segments of robotic arms to bend, stretch, and reorient in space with respect to other portions of the robot and other objects in the environment. The articulated robots 802 may be located at the first loading conveyor end 902 of a loading conveyor 804. The articulated robots 802 may be mounted on a robot base 908 supported by the first loading conveyor end 902. The articulated robots 802 may incorporate integrated 1D, 2D, and 3D perception systems, including robot-mounted cameras 904 comprising 2D and 3D cameras, capable of capturing image data used to determine quantity, size, location, and orientation of items of MTBH within a transport container. The robotic handling system 900 may use applied machine learning and artificial intelligence to detect boundaries of separate items of MTBH, such as boxes, cartons, or other items, classify them, locate them in 3D space, and optimize pick points and approach patterns of the articulated robots 802. These computational tasks may be separated into a dedicated on-board computing cluster that allows the robotic handling system 900 to achieve a high level of autonomy and a high pick rate. Such a computing cluster may utilize the unloading control system 1200 as illustrated in FIG. 12.

The articulated robots 802 may use a variety of visual sensors and sensor control feedback loops to grip, manipulate, and transport packages to the loading conveyor 804. The articulated robots 802 may be configured with multiple types of end effectors 906 that may use vacuum generated suction or other techniques to grasp and manipulate the packages. Typically the number of robotic DOF in the system is greater than twelve and may be as high as thirty-three.

The entire robotic handling system 900 is supported by a grounded base 806 assembly that distributes the weight of the system and provides stability during operation. The grounded base 806 may attach to the second loading conveyor end 910 through a base support 912 connected to a grounded base pivot 914 that allows the grounded base 806 to orient as needed on uneven or sloped container surfaces while maintaining the loading conveyor 804 in its desired position. A feedback loop may be configured between the telescoping transport conveyor and strain gauges on the robotic handling system 900 and the grounded base 806 that measure elastic deformation of components of the robotic handling system 900 corresponding to forces on those components. A proportional-integral-derivative loop may be established for force feedback, allowing the upward and downward forces that may be applied by the telescoping transport conveyor to keep the grounded base 806 grounded to the bottom of the container. A standard industrial controller such as a Beckhoff controller may be used to accomplish this. The grounded base 806 may include wheels 916 and/or tracks 918 or other passive mobility components that allow the robotic handling system 900 to be maneuvered and repositioned through the action of the telescoping transport conveyor and the efforts of the operations team.

The loading conveyor 804 provides additional DOF by rotating about loading conveyor pivot 920, with close loop control of the position via a translational actuator 922. The rotational position is recorded with a variety of 1D perception technologies like rotary encoders, or linear variable distance transceivers. Encoder feedback may provide the locations of the articulated robots 802 in free space at the end of the pivoting conveyor. Joint information may be provided based on a robot-mounted camera 904. Each time this camera scans an area, it may highlight a field of view captured as a 2D image or a 3D point cloud data. 2D data may be used to classify boxes, identifying where the boundaries and edges of each box are located. 3D data may be used along with the lines defining the box outlines to identify points on the surfaces in order to determine a picking position. In one embodiment, a picking position may be established as the coordinates of a point in the center of a picking face of the MTBH.

A mounting gantry 924 provides a mounting point for additional perception systems that record 1D, 2D, and 3D data to estimate the state and pose of the system. In one embodiment, these perception systems may include a forward-sensing multidimensional sensor system 926 and a multi-channel inertia measurement system 928. The robot base 908 may include sensor cutouts 930 that allow additional sensors such as cameras, light detection and ranging (LIDAR), and other sensors to detect objects and obstacles in front of the robotic handling system 900. Vibration, shock, acceleration, and alignment to the global magnetic field lines are recorded by such sensors during robotic handling system 900 operation.

A localized control system is presented that distributes power to the various devices and components, as well as provides the edge distributed logic. This localized control system may include a motor 932 and an industrial control box 934 that supports a programmable logic controller.

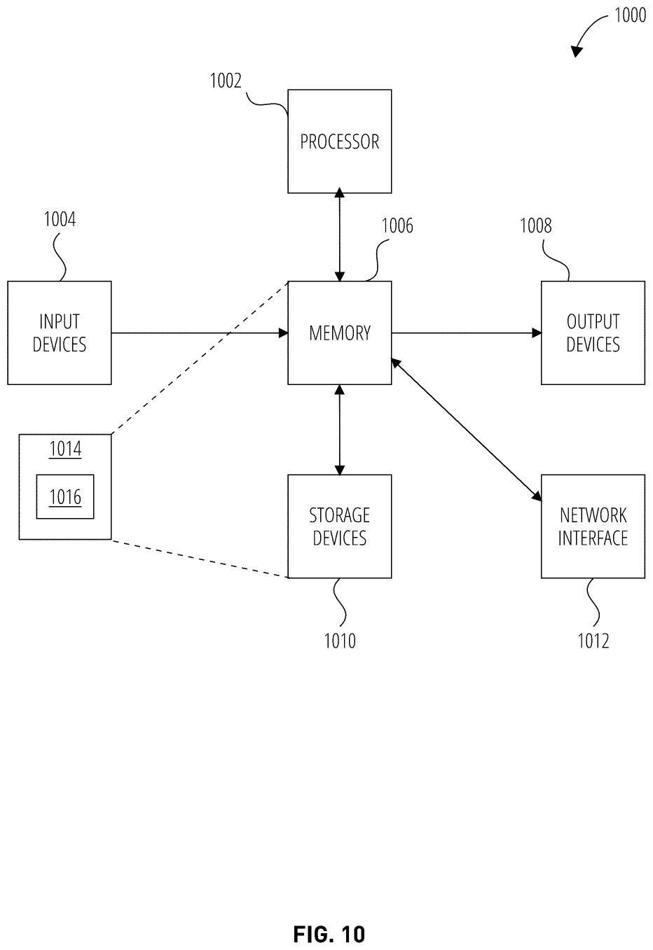

FIG. 10 depicts an embodiment of a computer system 1000 to implement components and process steps of the systems described herein. The computer system 1000 may comprise at least one processor 1002, input devices 1004, memory 1006, output devices 1008, storage devices 1010, a network interface 1012, an AI-based control logic 1014, and at least one model 1016.

Some or all portions of the computer system 1000 and its operational logic may be contained within the physical components of a robot, within a conventional desktop computer, within a computer server, and/or within a cloud server in communication with robotic and other computing devices, such as the elements of the automated ULD unloading system 100. In one embodiment, aspects of the computer system 1000 on networked or cloud based computing platforms may provide control for more than one robot at a time, allowing multiple robots to work in concert within a working space such as a material handling facility.

Input devices 1004 of a robot, desktop computer, programmable logic controllers (PLCs), industrial personal computers (IPCs), etc., comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 1004 are contact sensors which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 1004 are provided via various machine signal conductors (e.g., busses or network interfaces) and circuits to memory 1006.

The memory 1006 is typically what is known as a first or second level memory device, providing for storage (via configuration of matter or states of matter) of signals received from the input devices 1004, instructions and information for controlling operation of the central processing unit or processor 1002, and signals from storage devices 1010. Information stored in the memory 1006 is typically directly accessible to the processor 1002 of the device. Signals input to the device cause the reconfiguration of the internal material/energy state of the memory 1006, creating in essence a new machine configuration, influencing the behavior of the computer system 1000 by configuring the processor 1002 with control signals (instructions) and data provided in conjunction with the control signals.

Second or third level storage devices 1010 may provide a slower but higher capacity machine memory capability. Examples of storage devices 1010 are hard disks, optical disks, large capacity flash memories or other non-volatile memory technologies, and magnetic memories.

In one embodiment, memory 1006 may include virtual storage accessible through connection with a cloud server using the network interface 1012, as described below. In such embodiments, some or all of the AI-based control logic 1014 may be stored and processed remotely.

The processor 1002 may cause the configuration of the memory 1006 to be altered by signals in storage devices 1010. In other words, the processor 1002 may cause data and instructions to be read from storage devices 1010 in the memory 1006 from which may then influence the operations of processor 1002 as instructions and data signals, and from which it may also be provided to the output devices 1008. The processor 1002 may alter the content of the memory 1006 by signaling to a machine interface of memory 1006 to alter the internal configuration, and then converted signals to the storage devices 1010 to alter its material internal configuration. In other words, data and instructions may be backed up from memory 1006, which is often volatile, to storage devices 1010, which are often non-volatile. In one embodiment, the processor 1002 may be a central processing unit (CPU) or graphical processing unit (GPU).

Output devices 1008 are transducers which convert signals received from the memory 1006 into physical phenomenon such as vibrations in the air, or patterns of light on a machine display, or vibrations (i.e., haptic devices) or patterns of ink or other materials (i.e., printers and 3-D printers).

The network interface 1012 receives signals from the memory 1006 and converts them into electrical, optical, or wireless signals to other machines, such as the elements of the automated ULD unloading system 100, typically via a machine network. The network interface 1012 also receives signals from the machine network and converts them into electrical, optical, or wireless signals to the memory 1006. The network interface 1012 may allow a robot to communicate with networked desktop or server computing systems, a cloud server, a mobile device, other robots, and other network-connected devices.

The memory 1006 and/or the storage devices 1010 may store computer-executable instructions forming AI-based control logic 1014 that, when applied to and executed by the processor 1002, implement embodiments of the processes disclosed herein. AI-based control logic 1014 may include portions of a computer program, along with configuration data, that are executed by the processor 1002 or other processors configured in the computer system 1000.

AI-based control logic 1014 may include one or more models 1016 used to perform or supplement performance of the disclosed actions. Models 1016 may include machine learning models, AI models, generative AI models, agentic AI models, large language models, and other models known to those one of ordinary skill in the art.

In one embodiment, the AI-based control logic 1014 may, when executed by the processor 1002, configure the computer system 1000 in communication with the automated ULD unloading system 100 to manage a detection cache by receiving the spatial data generated by the perception system of the automated ULD unloading system for each individual MTBH, ordering and filtering detected MTBH based on the spatial data, and updating the detection cache as each individual MTBH is removed from the staging interface. The AI-based control logic 1014 may further configure the computer system 1000 to perform pick planning for a first articulated robot of the primary robotic handling system by generating, scoring, and caching motion plans determined using the spatial data, as well as picking poses, collision-avoidance constraints, and kinematic feasibility constraints as will be readily understood by one of ordinary skill in the art, each motion plan comprising a home trajectory, a pick trajectory, and a drop trajectory for the articulated robot. The AI-based control logic 1014 may further configure the computer system 1000 to coordinate single-arm execution of a planned pick by selecting a picking pose from the detection cache, controlling execution of a corresponding motion plan by the first articulated robot, preventing collisions with static or dynamic elements within an operating environment, and modifying a picking sequence based on execution outcomes and updates to a virtual representation of the discharged MTBH in the staging interface. These operations of the computer system 1000 as directed by the AI-based control logic 1014 may be performed in a manner similar to that described for the unloading control system 1200 introduced below.

In one embodiment, the primary robotic handling system of the automated ULD unloading system 100 may comprise two articulated robots. The AI-based control logic 1014 may in this case further configuring the computer system to identify a plurality of detected MTBH suitable for concurrent picking, select paired picking poses from the detection cache corresponding to the first articulated robot and the second articulated robot, generate paired motion plans comprising synchronized home, pick, and drop trajectory segments for the first articulated robot and the second articulated robot, and coordinate execution of the paired motion plans by synchronizing motion of the first articulated robot and the second articulated robot in time and space to prevent inter-robot interference during simultaneous picking operations.

For the purposes of this disclosure, a picking pose is a fully defined target configuration that the robotic system may reach in order to grasp a specific item of MTBH. A picking pose may include a picking position (where the end effector may contact an individual MTBH), and a picking orientation (the angular alignment of the end effector relative to the individual MTBH). These may define a pose in at least six degrees of freedom for an articulated robot of the primary robotic handling system in one embodiment. A picking pose is not simply a point in space. It is an instructional spatial state that a robotic control system may use as an input to motion planning, including pick planning. The disclosed system may calculate picking positions at the center of a detected face of each MTBH in one embodiment. The system may calculate picking orientations normal to that face to support reliable suction or mechanical engagement.

For the purposes of this disclosure, collision-avoidance constraints are explicit limitations imposed on motion planning to ensure that robot movement does not cause contact with other robots (dual-arm interference), MTBH other than that being picked or otherwise intentionally manipulated, structural elements of the automated ULD unloading system 100 (ULD walls, staging interface, conveyors, etc.), and dynamic elements (moving conveyors, tilting mechanisms). They are constraints on allowable motion paths, as well safety features, preventing harm to the automated ULD unloading system 100, nearby equipment, MTBH, and persons working in the area.

For the purposes of this disclosure, kinematic feasibility constraints ensure that a picking pose and its associated motion plan are physically achievable by a robot given joint limits, reachability, joint coupling, speed, acceleration, jerk limits, and base position (e.g., conveyor height or gantry position). Even if a picking pose is collision-free, it may not be reachable and executable by the robot's kinematic chain without over extending some component of the robot or incurring damaging forces upon some component of the robot or the MTBH.

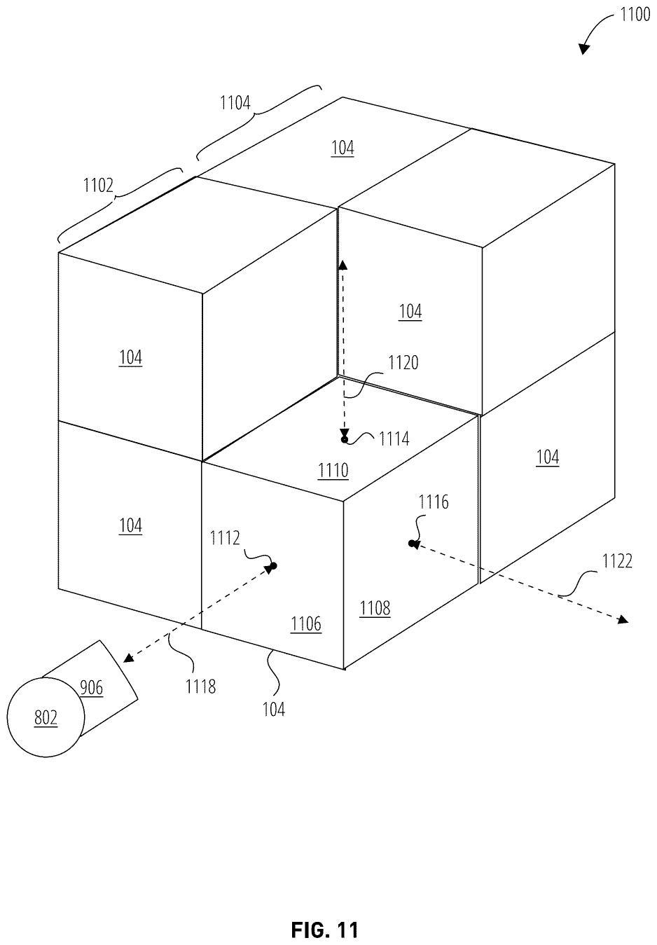

FIG. 11 illustrates MTBH calculated picking data 1100 in accordance with one embodiment. A first wall of MTBH 1102 and a second wall of MTBH 1104 are illustrated where the first wall of MTBH 1102 includes MTBH in the ULD 104 determined from perception scans to be closer to the nearest articulated robot 802, the second wall of MTBH 1104 being farther from the articulated robot 802.

The visible MTBH in the ULD 104 may be detected through perception scans and may be analyzed to detect available picking faces, such as picking face 1106, picking face 1108, and picking face 1110 as shown. Other picking faces may be inferred from perception scan data but may or may not be included in calculations to determine picking data. In one embodiment, hidden faces may be analyzed as a particular picking sequence may be expected to reveal picking faces not accessible at the time of the perception scan.

For the three picking faces visible for the MTBH in the ULD 104 under examination in this figure, a picking position may be determined for each face. The picking position may reside in a calculated cartesian central point on the picking face. Such picking positions are shown as picking position 1112 on picking face 1106, picking position 1114 on picking face 1110, and picking position 1116 on picking face 1108.

For each picking face, a picking orientation may also be calculated. The picking orientation may be in a direction that is normal to the plane of the picking face, such that the end effector 906 of an articulated robot 802 may make secure contact against the picking face, then begin moving in the direction normal to that face to initiate picking of the MTBH in the ULD 104. Examples of picking orientations are shown here as picking orientation 1118 for picking face 1106, picking orientation 1120 for picking face 1110, and picking orientation 1122 for picking face 1108.

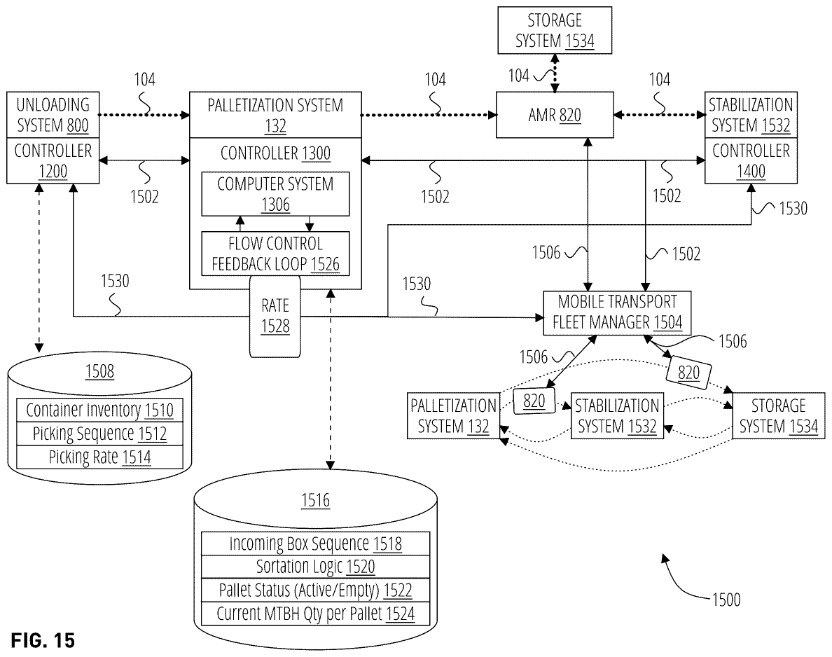

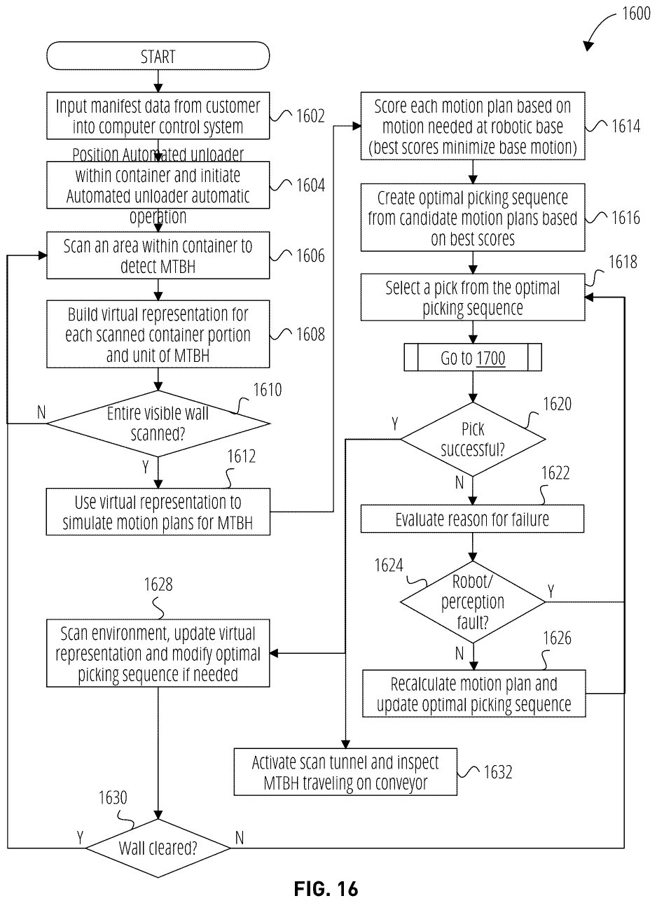

FIG. 12 illustrates an unloading control system 1200 in accordance with one embodiment. The unloading control system 1200 may comprise perception systems 1202, industrial control systems 1204, and computer system 1206 configured to perform the disclosed activities, as described with respect to the automated truck unloading routine 1600 of FIG. 16 and the end-to-end control system diagram 1500 of FIG. 15.

In one embodiment, the perception systems 1202 may receive input from camera systems 1208, load cells 1210, pressure sensors 1212, and other sensors 1214 such as LIDAR, inertia measurement units, sonic locators, etc. The industrial control systems 1204 may include control for the pneumatics 1216 and hydraulics 1218 for the industrial equipment of the robotic unloading system 800, as well as encoders 1220 and motors 1222 for the mechanical and robotic components of the robotic unloading system 800.

The computer system 1206 of the unloading control system 1200 may comprise computer systems 1000 such as are described with respect to FIG. 10. The data and logic needed to perform the disclosed activities may be stored on any number of computer systems 1000 including the computer system 1206, which may be connected via wired and/or wireless network technology.

“Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

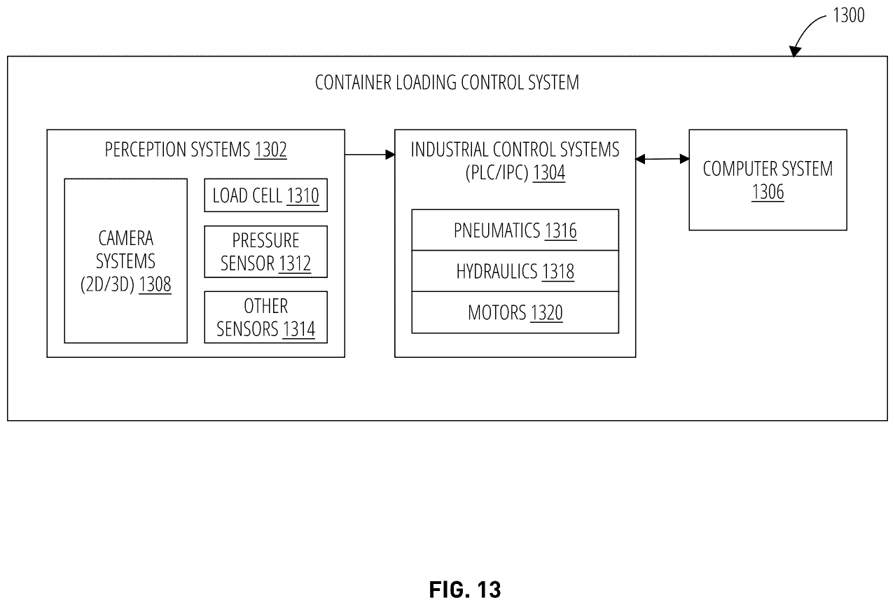

FIG. 13 illustrates an unloader container loading control system 1300 in accordance with one embodiment. The container loading control system 1300 may comprise perception systems 1302, industrial control systems 1304, and computer systems 1306 configured to perform the disclosed activities, as described with respect to the downstream sorting and loading system 132 of FIGS. 5 and 8 and the end-to-end control system diagram 1500 of FIG. 15.

In one embodiment, the perception systems 1302 may receive input from camera systems 1308, load cells 1310, pressure sensors 1312, and other sensors 1314 such as LIDAR, inertia measurement units, sonic locators, etc. The industrial control systems 1304 may include control for the pneumatics 1316, hydraulics 1318, and motors 1320 for the industrial equipment of the downstream sorting and loading system 132.

The computer system 1306 of the container loading control system 1300 may comprise computer systems 1000 such as are described with respect to FIG. 10. The data and logic needed to perform the disclosed activities may be stored on any number of computer systems 1000 including the computer system 1306, which may be connected via wired and/or wireless network technology.

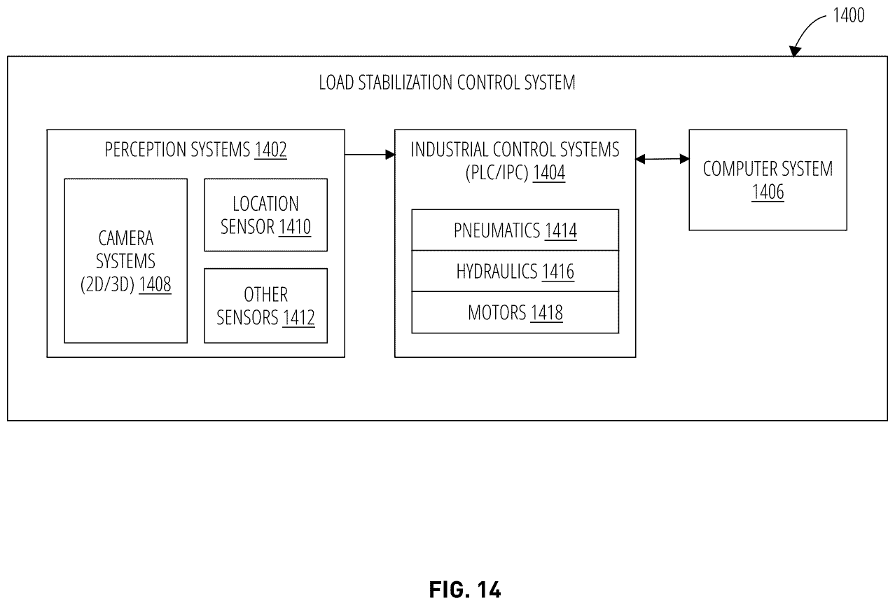

FIG. 14 illustrates an unloader load stabilization control system 1400 in accordance with one embodiment. The load stabilization control system 1400 may comprise perception systems 1402, industrial control systems 1404, and computer systems 1406 configured to perform the disclosed activities, as described with respect to the automated cart loader 1532 and the end-to-end control system diagram 1500 of FIG. 15.

In one embodiment, the perception systems 1402 may receive input from camera systems 1408, location sensors 1410, and other sensors 1412 such as LIDAR, inertia measurement units, sonic locators, etc. The industrial control systems 1404 may include control for the pneumatics 1414, hydraulics 1416, and motors 1418 for the industrial equipment of the automated cart loader 1532.

The computer system 1406 of the load stabilization control system 1400 may comprise computer systems 1000 such as are described with respect to FIG. 10. The data and logic needed to perform the disclosed activities may be stored on any number of computer systems 1000 including the computer system 1406, which may be connected via wired and/or wireless network technology.

FIG. 15 illustrates an end-to-end control system diagram 1500 in accordance with one embodiment. The end-to-end control system diagram 1500 shows key communications and MTBH flow between the robotic unloading system 800, the downstream sorting and loading system 132, the mobile transport fleet manager 1504 and the AMRs 820 it manages, the automated cart loader 1532, and the automated crane storage and retrieval system 1534, in order to manage unloading, handling, and storage of MTBH in the ULD 104 throughout a material handling facility.

The robotic unloading system 800 may be configured with an unloading control system 1200, such as that illustrated in FIG. 12. The downstream sorting and loading system 132 may be configured with a robotic unloading system 800 such as that illustrated in FIG. 13. The automated cart loader 1532 may be configured with a load stabilization control system 1400 such as that illustrated in FIG. 14. Each of these controllers may include computer systems that transmit control communications 1502 to each other over a wired or wireless network. These controllers may further be networked to communicate with the mobile transport fleet manager 1504 that manages the AMRs 820 via wireless fleet control 1506. In one embodiment, all of the computer systems within a material handling facility may be wired to a facility-wide EtherCAT network.

The unloading control system 1200 may access and update stored unloading data 1508, such as container inventory 1510, picking sequence 1512, and picking rate 1514. The container loading control system 1300 may access and update stored palletization data 1516 such as incoming box sequence 1518, sortation logic 1520, pallet status 1522, and current MTBH quantity per pallet 1524.

During a typical material unloading and handling job, MTBH in the ULD 104 may be transferred from the robotic unloading system 800 to the downstream sorting and loading system 132, via conveyors and other MHE. After palletization, the MTBH in the ULD 104 may be carried by AMRs 820 to either the automated cart loader 1532 in order to be wrapped for storage without a pallet sleeve or sent directly to the automated crane storage and retrieval system 1534 for storage within a pallet sleeve. Shrink wrapped pallet loads may be accepted by AMRs 820 and carried thence to the automated crane storage and retrieval system 1534.

The speed at which the end-to-end system functions may be determined by the rate at which MTBH in the ULD 104 is palletized at the downstream sorting and loading system 132. The container loading control system 1300 may receive manifest information, including the quantity, size, and type of MTBH in the ULD 104 included in a container to be unloaded. Using this information, the container loading control system 1300 may determine a set of pallet loads to be filled as unloaded MTBH in the ULD 104 arrives at the downstream sorting and loading system 132. This data may be used by sorting MHE feeding the downstream sorting and loading system 132.

In one embodiment, MHE may direct the MTBH to a small buffer lane. However, when the MTBH flows directly to the downstream sorting and loading system 132, the number in the shipping manifest may be accounted for as palletized and may be used to inform the robotic handling system 900 as to the picking order to optimally fill the pallet or pallets in progress. The robotic handling system 900 may be programmed to pick-to-exhaustion to reduce the amount of MTBH that needs to be sidelined or sorted to a buffer area.

In one embodiment, the manifest data, in combination with other stored unloading data 1508, as well as picking sequence 1512 data that may be provided by the unloading control system 1200, may be used by the computer system 1306 of the container loading control system 1300 as inputs to a flow control feedback loop 1526 to monitor or calculate a rate 1528 at which palletization is performed by the downstream sorting and loading system 132. Rate data 1530 may then be communicated out as part of control communications 1502 to other control components such as the mobile transport fleet manager 1504, the unloading control system 1200 of the robotic unloading system 800, and the load stabilization control system 1400 of the automated cart loader 1532. These components may use the rate data 1530 to control the speeds at which they perform their local tasks, in order to provide the smoothest flow of MTBH in the ULD 104 across the entire end-to-end system.

FIG. 16 illustrates an example automated truck unloading routine 1600 that may be performed by the automated unloader (Automated unloader) such as the robotic handling system 900 illustrated in FIG. 9A and FIG. 9B. Although the example automated truck unloading routine 1600 depicts a particular sequence of operations, the sequence may be altered without departing from the scope of the present disclosure. For example, some of the operations depicted may be performed in parallel or in a different sequence that does not materially affect the function of the automated truck unloading routine 1600. In other examples, different components of an example device or system that implements the automated truck unloading routine 1600 may perform functions concurrently or in a specific sequence.

According to some examples, the automated truck unloading routine 1600 includes inputting shipping manifest data provided by a customer into a computer control system at block 1602. The computer control system may include one or more computer systems 1000 as described with respect to FIG. 10. Shipping manifest data may include an inventory of each item of MTBH within a container, including the SKU, weight, height, width, and length of each MTBH.

According to some examples, the automated truck unloading routine 1600 includes positioning a robotic handling system 900 within a transportation container. An onsite operations team at the material handling facility may receive the container, trailer, or truck at a loading dock. The container may be opened by the team and the Automated unloader may be manually placed within the container at a location suitable for the automated unloader's initial scans and movements upon beginning automated operation. The team may then place the Automated unloader into its automated mode, and the Automated unloader may initiate automatic operation at block 1604.

According to some examples, the automated truck unloading routine 1600 includes scanning an area within container to detect MTBH at block 1606. The scan may be performed by perception sensors such as cameras, LIDAR, barcode scanners, etc. In one embodiment, the sensors may provide a detailed scan of a three-foot by three-foot area, such that one scan may not cover an entire wall of boxes or packages comprising the MTBH stacked within a trailer, truck, or other container. To provide complete coverage, each articulated robot may use its camera to create a map of its side of the container, ensuring an overlap between the scans taken. In such a case, the Automated unloader may begin scanning at a default upper-left position based on anticipated or inputted dimensions of the shipping container or trailer. In another embodiment, a lower resolution overall scan may be acquired first to indicate initial dimensions for a wall of MTBH stacked within the container, with more detailed scanning beginning with upper-leftmost MTBH detected. A scan may in some embodiments take on the order of 0.5 seconds to acquire and process, allowing scans to be taken of multiple areas without a deleterious loss of time.

The system may scan the face of boxes stacked within a container, and may locate them in three-dimensional space with regard to three cartesian locations and three rotational offsets from a principal axis. This is the amount of information needed to define a three-dimensional object in three-dimensional space. The three translational components and three rotational components may define the position and orientation of the boxes in space, and from that the face of each side, and the contact normal point that is represented as the centroid of the picking face.

In circumstances where the picking face is not flat, an approximation of the centroid over the surface topology may be made. In one embodiment, the robotic handling system 900 may comprise two separate industrial collaborative robots attached to the base of the Automated unloader, as illustrated in FIG. 9A. Each robot may be responsible for scanning its own portion of the shipping container (i.e., the right portion or the left portion, as sensed by the robots facing directly into the container). The two portions may include some overlap to ensure that no gaps are left in the scanned MTBH data.

According to some examples, the automated truck unloading routine 1600 includes building virtual representation for each scanned container portion and unit of MTBH at block 1608. The virtual representation in one embodiment may be generated by the master robot controller or robot operating system (ROS) computer. The program may have underlying code that sets up the expected environment and parameters, and interfaces to provide TCP/IP control over the motion of the robot. Behavior trees may be used to complete the virtual representation from the robotic scans. Behavior trees provide a mathematical model comprising a root node, control flow nodes, and execution notes, and are used to represent complex operations as a series of simple operations, as is well understood by those of skill in the art. The software stack for the system may run on a simulation framework such as Gazebo. RViz or similar programs may be used to represent the visualization of perception sensors.

The virtual representation may use an estimate of six DOF for the pose of each unit of MTBH detected within the container. In one embodiment, the Automated unloader control system may access the shipping manifest inputted in block 1602 via an application programming interface (API) connection to the customer's warehouse management system. The virtual representation may be verified for expected boxes, and data provided by the manifest may be used to confirm that the boxes detected are within the handling constraints of the unloading robots. For example, unloading robots may be able to handle MTBH with dimensions at or below 24 inches and having a weight of 30 pounds or less. Where any detected and manifested items exceed those parameters, these may be ignored in the resulting unloading plans, or may necessitate handling such as pushing to one side rather than picking up.

If the entire visible wall has not yet been scanned at decision block 1610, the automated truck unloading routine 1600 may return to block 1606 in order to identify and scan a next area of the container interior. This next scanning area may overlap with the previous area scanned such that no gaps are left in the scanned MTBH data. If the entire visible wall has been scanned at decision block 1610, the automated truck unloading routine 1600 may continue to block 1612.

According to some examples, the automated truck unloading routine 1600 includes using the virtual representation built iteratively through the completion of block 1608 for the entire visible wall scanned to simulate motion plans for MTBH at block 1612. For each candidate item of MTBH, motion paths that are feasible, safe, and complete from source location to destination location may be calculated. However, each face of the MTBH is not always available, so the picking sequence may also be taken into account. The motion plans for each MTBH may be functions of the incremental positions to be assumed by the moveable base attaching the industrial collaborative robots to the loading conveyor. Motion plans such as those provided in the Open Motion Plan Library (OMPL) generated by Kavraki Lab may be used.

Different motion plans may control the robots for different segments. For example, where it is important that the robot follow a particular line of motion, cartesian motion planning may be used. Where space to operate is constrained, a probabilistic roadmap may be constructed and stored as a graph with nodes corresponding to collision-free configurations and edges corresponding to feasible paths of motion between those configurations. Motion plans may take in the state of the environment (such as absolute and relative locations of the six sides of each box within the bounds of a container), the state of the robotic handling system 900 (such as robot joint angles, encoder data, and information from other sensors), and a high-level plan from behavior trees. The output of the motion plan may be a trajectory comprising a sequence of six floating point variables representing the joint angles as a function of time, which may be sent to the motors of the robots for execution.

The scanned data may be added to a learning library in some embodiments and may be input into machine learning in order to train a machine algorithm to more expeditiously detect and identify MTBH from classification and segmentation of features detected through scanning sensors. In one embodiment, a machine learning installation such as Fizyr may be used. Machine learning may over time assist in understanding the pose of MTBH for a good pick given candidates detected. Successful and failed picks may be used for reinforcement learning.

The virtual representation may also be stored for use in internal testing and verification, as well as continuous integration of new data, such that a “digital twin” of the real-world packing configuration of the shipping container is maintained. The digital twin conceptualization, familiar in the fields of automation and robotics, provides the ability to test operation code in a simulation environment before or in parallel with execution in the real environment.

According to some examples, block 1614 of the automated truck unloading routine 1600 includes scoring each motion plan generated at block 1612 based on motion needed at the robotic base in order to accomplish the pick. As described with respect to FIG. 9A and FIG. 9B, industrial collaborative robots that accomplish the picking may be mounted on a base residing at the end of a loading conveyor that is capable of lateral motion forward and backward (i.e., extension further into the container or retraction toward and out of the container opening), as well as rotational motion from left to right (pivoting at the illustrated loading conveyor pivot). In one embodiment, the load conveyor may also be able to pivot upward and downward at the loading conveyor pivot through lifting mechanisms. These ranges of motion provided at the base may also be referred to as auxiliary DOF (in contrast with the six DOF that may be provided by each individual robot). The best scores for each motion plan may be associated with plans that minimize this lateral and rotational motion of the base, as well as vertical adjustments where applicable. In one embodiment, factors such as position, velocity, acceleration, jerk, snap, trajectory normalized distance, and other attributes related to the configuration space, free space, target space, and obstacle space may be involved in scoring. The scoring algorithm may apply different weights to these variables based on the different physical environment configurations and properties of the MTBH. For example, jerk and snap may be weighted more heavily when the MTBH is anticipated to contain fragile objects.

According to some examples, the automated truck unloading routine 1600 includes creating an optimal picking sequence from the candidate motion plans having the best scores at block 1616. Optimal picking sequences may include dual arm picking strategies for difficult MTBH (contrasting with a typical case of one robotic arm picking one item of MTBH independent of the actions of the other robot). The optimal picking sequences may also account for synchronization between the motions of the two arms, in order to prevent the actions of one robot to disrupt the actions of or even damage the other robot. Optimal picking sequences may also take into account timing for the motions of the tilting conveyor and may maximize the manipulability of the robot arms. To calculate these picking sequences, motion plans on each feasible face may be examined.

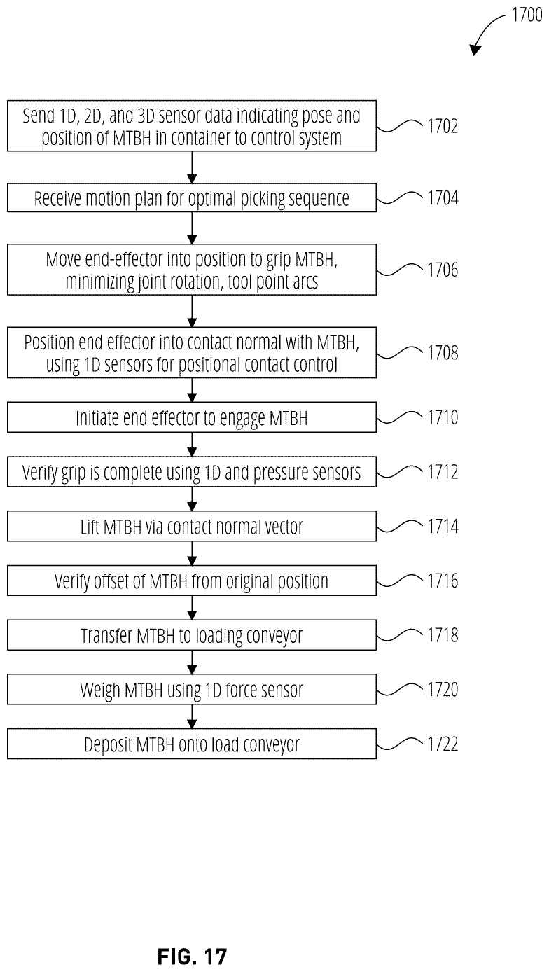

According to some examples, the automated truck unloading routine 1600 includes selecting a pick from the optimal picking sequence at block 1618. Each robot may independently perform a series of picks from the sequence according to the steps of the pick routine for individual articulated robot 1700 illustrated in FIG. 17. In one embodiment, the system may place the first item of MTBH onto an exception path conveyor rather than the loading conveyor, so that this item may be easily inspected later by the operations team. Where the container has been snake SKU loaded, or where its contents are mixed, the system may place the first of each unique SKU onto the exception path conveyor.

Different sizes of MTBH may impact the speed at which the articulated robots may perform the picks of the picking sequence. For very small boxes, the robotic handling system 900 may be able to unload 700 to 1,400 cases per hour (CPH). Small and medium boxes, which the end effectors of the articulated robots may be primarily designed to handle, may be unloaded at a rate of 800 to 1,100 CPH and 800 to 1,200 CPH, respectively. Large boxes, such as those that are more than 20 inches in each dimension, may have a typical unloading rate of 600 to 900 CPH.

At decision block 1620, the automated truck unloading routine 1600 may determine whether or not the pick performed via pick routine for individual articulated robot 1700 was successful. If it is determined that the pick was not successful, the reason for failure may be evaluated at block 1622. A pick failure may be the result of an articulated robot fault, an end effector fault, a perception fault, a motion planning fault, or various other static or dynamic conditions in the unloading environment. If the failure is determined to be a robot, end effector, or perception fault at decision block 1624, the automated truck unloading routine 1600 may return to select a different pick from the optimal picking sequence at block 1618.

If the failure was determined to be due to reasons other than robot, end effector, or perception fault at decision block 1624, the motion plan may be recalculated and the picking sequence updated at block 1626. The motion plan and picking sequence may be recalculated based on the aspect ratio of the picking face of the item being picked, the item's weight as indicated in the shipping manifest, and/or individual dimensions of the object, such as its height, its width, or its length. The motion plan and picking sequence may also be updated based on the item's position relative to other MTBH, or other parameters of the environment comprising the container and MTBH. The new pick may be executed at this time or may be included in the picking sequence for later execution. The automated truck unloading routine 1600 my return to block 1618 to continue picking MTBH.

In one embodiment, if a fault, exception, or other failure occurs during operation in automatic mode, the operations team may stop automatic operation and enter a manual or maintenance mode. In one embodiment, the operations team may choose to manually remove the MTBH incurring the exception, setting it to the side, and may then allow the robotic handling system 900 to continue operating in automated mode.

If the pick is determined to have been successful at decision block 1620, the automated truck unloading routine 1600 may continue to block 1628. According to some examples, the automated truck unloading routine 1600 includes scanning the environment, updating the virtual representation, and modifying the optimal picking sequence if needed at block 1628. In this manner, the digital twin of the container environment may be updated to account for the removal of the picked MTBH and may include MTBH newly revealed by the gap created by picking the previous item. If a new item of MTBH is detected, its position may be resolved and it may be added to the virtual representation. If a box that is already part of the virtual representation is detected, its scanned position may be compared to its position in the virtual representation to ensure that it has not moved to an extent that would disrupt its previously identified pick strategy. For example, if the MTBH has moved more than a position change threshold, its virtually represented position and its portion of the motion plan may be updated. Such a threshold may be absolute, such as three inches, or proportional, such as 40% of the item's dimension in the direction of motion (i.e., 4 inches for a 10-inch wide object that has shifted horizontally). In one embodiment, robot-mounted cameras or other sensors may be instructed to scan manually or automatically on-demand at any time during operation if a fault is detected in performance or the visual representation.

From decision block 1620, for successful picks, the automated truck unloading routine 1600 may also branch to block 1632. At block 1632, the scanning tunnel may be activated to inspect MTBH placed on the conveyor by the articulated robot performing pick routine for individual articulated robot 1700. In this manner, MTBH may be inspected as it travels along the telescoping transport conveyor toward the automated cart loader. The scanning tunnel may perform a five- or six-sided scan to identify the MTBH with respect to expected items in the manifest using optical character recognition (OCR), machine learning, pattern matching, or other identification techniques that may be employed based on 2D and 3D imaging performed in the scanning tunnel. These techniques and actions may include turning on light panes when MTBH breaks a retro-reflective sensor beam, capturing an image from the scanning tunnel cameras, extracting logistics information such as SKU based on extraction and analysis of MTBH labels from image data, and verifying the extracted labels with the manifest for the container being unloaded.

At decision block 1630, the automated truck unloading routine 1600 may determine whether the visible wall scanned in blocks 1606 to 1610 has been entirely cleared. If the wall has not yet been cleared, the automated truck unloading routine 1600 may return to block 1618 to execute the next pick in the picking sequence. If the wall has been cleared at decision block 1630, the automated truck unloading routine 1600 may return to block 1606 to examine a next wall of MTBH, or to determine that no additional MTBH remains in the container. Once all MTBH has been removed from the container, the robotic handling system 900 may retract back onto the dock automatically and may wait to be put into service with a new container.

FIG. 17 illustrates an example pick routine for individual articulated robot 1700. Although the example pick routine for individual articulated robot 1700 depicts a particular sequence of operations, the sequence may be altered without departing from the scope of the present disclosure. For example, some of the operations depicted may be performed in parallel or in a different sequence that does not materially affect the function of the pick routine for individual articulated robot 1700. In other examples, different components of an example device or system that implements the pick routine for individual articulated robot 1700 may perform functions concurrently or in a specific sequence.

According to some examples, the pick routine for individual articulated robot 1700 includes sending 1D, 2D, and 3D sensor data indicating pose and position of MTBH in a container to a control system at block 1702. 1D sensors may include pressure sensors, load cells, sonic locators, or similar sensors that capture information relative to a one-dimensional point in space. 2D sensors may include cameras capable of capturing two-dimensional images representing a field of vision within the container. 3D sensors may include imaging technologies capable of detecting or calculating depths within a field of vision as well as the planar data captured by a 2D sensor. The control system may include or be connected to the unloading control system 1200 described with respect to FIG. 12.

According to some examples, the pick routine for individual articulated robot 1700 includes receiving motion plan for optimal picking sequence at block 1704. Motion plans may act to minimize the motion needed across non-robotic or auxiliary DOFs, as is described with respect to automated truck unloading routine 1600. The picking sequence data may instruct the robot how to move across its at least six DOF within three-dimensional space in order to contact a desired surface of an item of MTBH.

According to some examples, the pick routine for individual articulated robot 1700 includes moving its end effector into position to grip MTBH, minimizing joint rotation and tool point arcs at block 1706, following the discrete steps provided by the motion plan.

According to some examples, the pick routine for individual articulated robot 1700 includes positioning an end effector into contact normal with MTBH, using 1D sensors for positional contact control at block 1708. Contact normal refers to a position in which the end effector may engage with the MTBH in such a way that motion in a direction normal or perpendicular to the face of contact allows the articulated robot to pick the MTBH out of a wall or stack of other MTBH.

According to some examples, the pick routine for individual articulated robot 1700 includes initiating the end effector to engage MTBH at block 1710. In one embodiment, the end effector may be a pneumatic vacuum end effector. Initiating such an end effector may include making physical contact with a flat surface of the MTBH and engaging vacuum suction so as to pull the MTBH securely against the end effector, such that it may be held by this vacuum force as the articulated robot pulls it against the friction forces exerted by neighboring MTBH, and remains securely held against gravitational and inertial forces as the robot arm traverses empty space from the MTBH wall or stack to the loading conveyor. In another embodiment, the end effector may comprise fingers that engage with a pinching motion, or some other securement feature that may be engaged with MTBH, as will be readily understood by one of skill in the art.

According to some examples, the pick routine for individual articulated robot 1700 includes verifying grip is complete using 1D and pressure sensors at block 1712. If the grip is not verified as complete, the robot may return to the beginning of the pick routine for individual articulated robot 1700, or may exit the pick routine for individual articulated robot 1700, allowing other actions to be taken in order to achieve a successful grip.

According to some examples, the pick routine for individual articulated robot 1700 includes lifting MTBH via the contact normal vector at block 1714 once the grip has been verified. In one embodiment, an offset of the MTBH from its original position may be verified at block 1716. This may provide another layer of confirmation that the grip is complete, and may allow a point of observation and calculation to ensure that nothing is currently obstructing the intended path of motion for the MTBH to the loading conveyor.

According to some examples, the pick routine for individual articulated robot 1700 includes transferring the MTBH to the loading conveyor at block 1718. The automated truck unloading routine 1600 may then at block 1720 weigh the MTBH using 1D force sensor at block 1720. In some embodiments, weighing may be completed by some other process, such as matching to a package manifest, using sensors in the loading conveyor or along other points of transit away from the container. The pick routine for individual articulated robot 1700 may conclude with depositing MTBH onto the loading conveyor at block 1722.

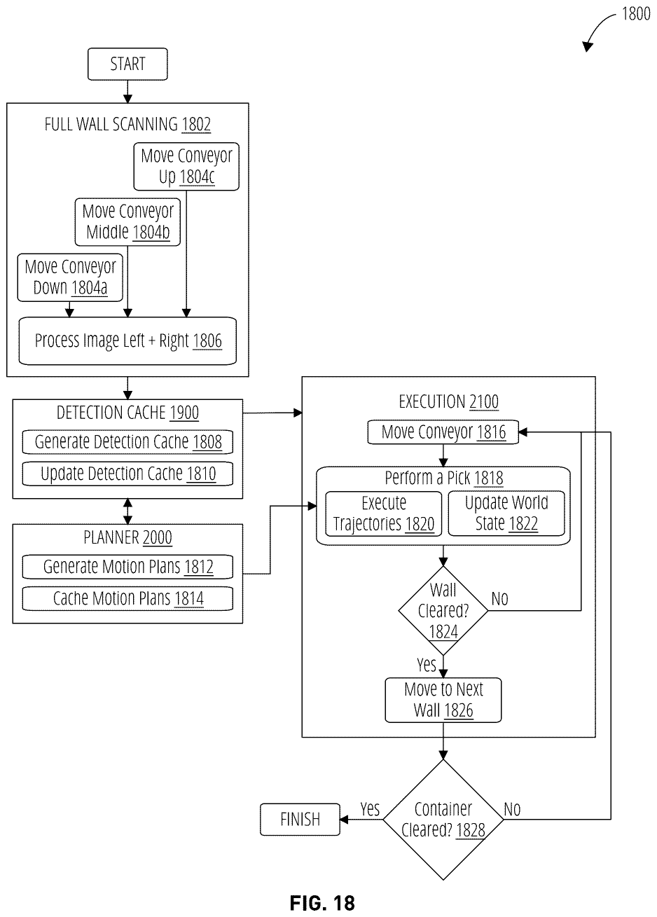

FIG. 18 illustrates an automated truck unloading flow diagram 1800 in accordance with one embodiment. The steps illustrated may be performed by the unloading control system 1200 described in FIG. 12. Broadly speaking, the automated truck unloading flow diagram 1800 indicates how the unloading control system 1200 may perform the automated truck unloading routine 1600 in one embodiment.

The automated truck unloading flow diagram 1800 may begin with a full wall scanning 1802 step. A move conveyor down 1804a step, a move conveyor middle 1804b step, and a move conveyor up 1804c step may be performed, each followed by a process left and right images 1806 step. In this manner, or in more or fewer similar steps, a full wall of MTBH may be scanned within a container.

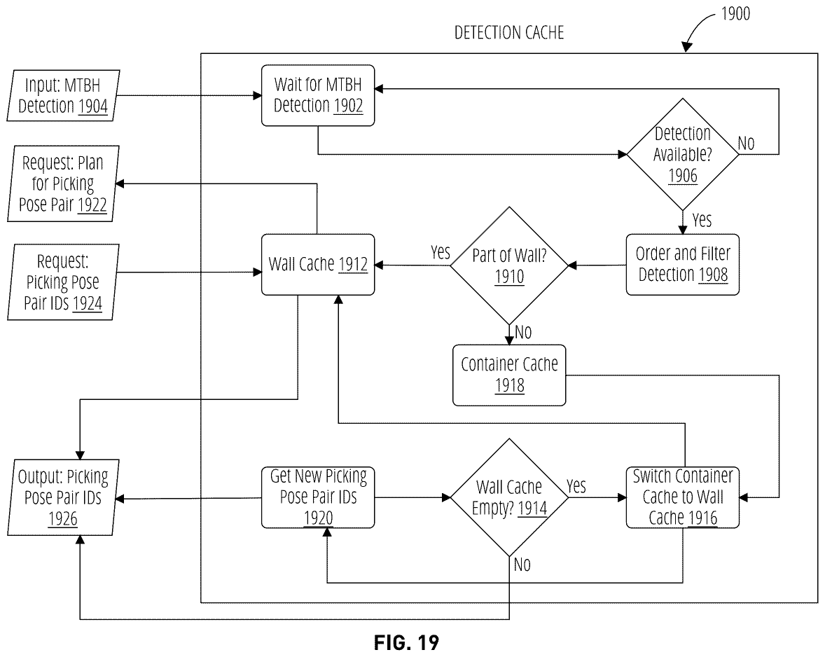

After full wall scanning 1802 is complete, the flow of work may proceed to the detection cache flow diagram 1900. This is described in greater detail with respect to FIG. 19. Broadly speaking, the detection cache flow diagram 1900 may include generate detection cache 1808 steps and update detection cache 1810 steps.

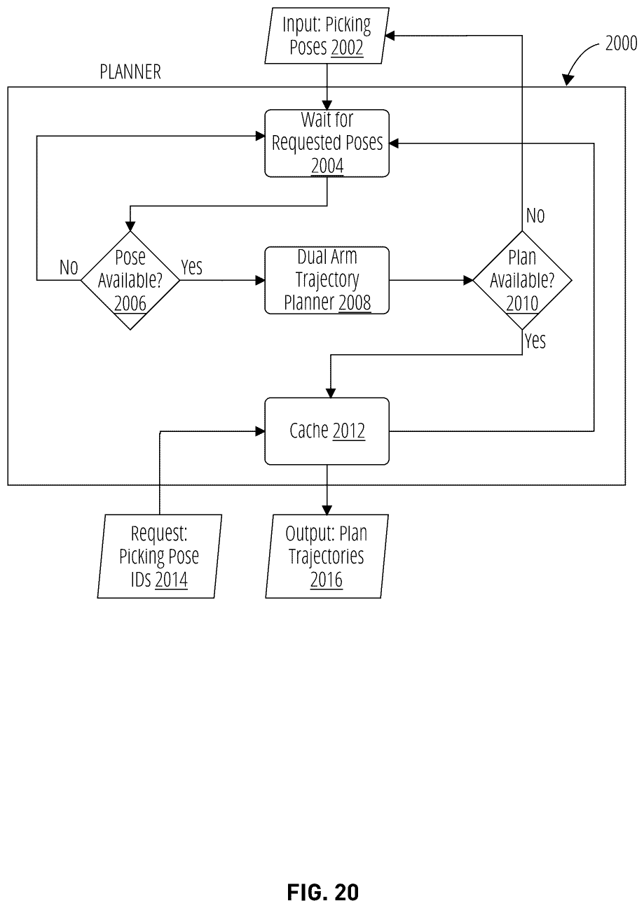

Data generated during flow described in the detection cache flow diagram 1900 may be used by planner operations as described by planner flow diagram 2000 illustrated in FIG. 20. Through operation according to the planner flow diagram 2000, motions plans may be generated at a generate motion plans 1812 step, and may be cached at a cache motion plans 1814 step.

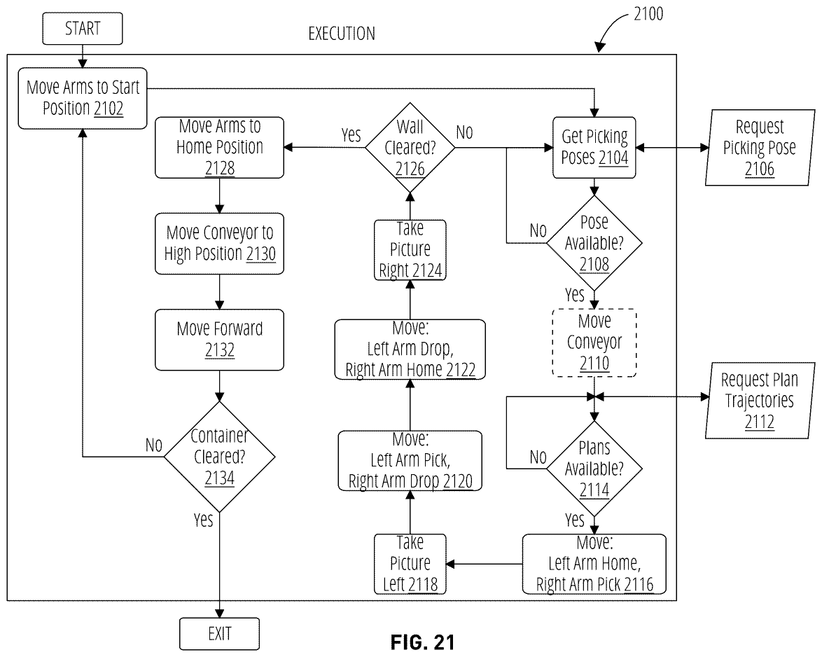

Detection cache data from the detection cache flow diagram 1900 and planning data from the planner flow diagram 2000 may be provided for use during execution as described with respect to the execution flow diagram 2100 illustrated in FIG. 21. The execution flow diagram 2100 may proceed with a move conveyor 1816 step to locate robotics within proximity to perform a pick 1818, as indicated by motion plans generated through operation according to the planner flow diagram 2000. Completing the perform a pick 1818 step may include action to execute trajectories 1820 to contact the picking face and action to update world state 1822 based on changes incurred through the execute trajectories 1820 step. A wall cleared 1824 check may be made, and if the wall is not cleared, the execution flow diagram 2100 may return to the move conveyor 1816 step. If the wall is cleared, the execution flow diagram 2100 may proceed to move to next wall 1826. Execution flow diagram 2100 may continue as long as there is MTBH in the container. Execution may end when all walls are cleared, as determined at a container cleared 1828 check.

FIG. 19 illustrates a detection cache flow diagram 1900 in accordance with one embodiment. The detection cache flow diagram 1900 may begin by waiting to receive data on MTBH detection 1902. The detection cache flow diagram 1900 may receive MTBH detection 1904 data based on analysis of image and point cloud data captured during perception scans. If at the detection available 1906 check, data is not available, the detection cache flow diagram 1900 will continue to wait. If available, an order and filter detection 1908 step may be performed.

MTBH detection data may contain information on material to be handled that corresponds to picking poses for gripping that material and segmentations of the paths to be traversed to achieve the picking poses. Picking poses refers to the position an articulated robot may need to achieve in order to grasp an item of MTBH. These picking poses for detected MTBH may or may not pertain to MTBH that is part of the scanned wall for which unloading is in progress. If the data is determined at the part of wall 1910 check, it may be saved in a wall cache 1912. If it is not part of the wall, it may be saved in container cache 1918.

The detection cache flow diagram 1900 may request a picking pose pair plan 1922 as output from the planner flow diagram 2000. A picking pose pair may refer to the two picking poses indicated for a coordinated action step by the two articulated robots. One of the pair of picking poses may be for execution by the left-hand articulated robot, while the other of the pair may be executed by the right-hand articulated robot. The picking pose pair plan may include a set of trajectories describing the movements each of the two articulated robots may need to perform to complete the next portion of a motion plan. The planner flow diagram 2000 may include acting to send a request for the identifiers (IDs) for the picking pose pair the plan has been requested for (picking pose pair IDs 1924) back to the detection cache. These picking pose pair IDs 1926 may be provided by the detection cache to the planner or to execution flow.

If the wall cache empty 1914 check indicates the wall cache is empty, the switch container cache to wall cache 1916 may be performed. At this point, a get new picking pose pair IDs 1920 task may be completed, and the picking pose pair IDs 1926 output.

For the following parameters:
d: vector of detections
wallCache: vector of all the detections that are close to the system
containerCache: vector of all the detections that do not belong in the wall cache pseudocode corresponding to this detection cache flow diagram 1900 may be as follows:

```
When MTBH d are received
  Order and filter d - sort d by depth first, then top, then
from center
  if the d is close
    assign it to the wallCache
  else
    assign to the containerCache
When request for trajectories reference received
  check wallCache
  if wallCache empty
    wallCache equals containerCache
  go back to top
  return d IDs
For picking pose pair
  if there is no plan
    request plan with pair
  End For
```

The planner flow diagram 2000 may take as input a requested pair of picking poses from detection cache 2002. These are the picking poses for two different detections provided by the detection cache. The planner flow diagram 2000 may include a wait for requested poses 2004 if no poses are deemed available at the pose available 2006 check. If picking poses are available, the dual arm trajectory planner 2008 may act to determine a plan for the requested picking poses. If a plan available 2010 check indicates no plan is available, the planner may wait for the next request. In one embodiment, the planner may send a success or failure indication to the detection cache.

If a plan is available as determined at the plan available 2010 check, the send trajectory to cache 2012 step may be performed. The planner may request picking pose IDs from detection cache 2014, and may output plan trajectories for requested picking pose pair 2016. These are the generated trajectories. Each trajectory has three different sub-trajectories, namely: 1) Home, 2) Pick and 3) Drop. Each sub-trajectory of each arm may be synchronized in orchestration with the entire system, as described with respect to the execution flow diagram 2100 illustrated in FIG. 21.

For the following parameters:
p=<pₗ, pᵣ>: pair of picking poses requested
t=<tₗ, tᵣ>: pair of planned trajectories
   pseudocode corresponding to this detection cache flow diagram 1900 may be as follows:

```
When p are received:
  assign pₗ to left arm and pₗ to right arm
  t =< tₗ,tᵣ > = Create motion plan from t =< tₗ,tᵣ >
  if t is not empty:
    cache t and assign a unique ID to it
    return with Plan successful
  else
    return with Plan failed
When queried with specific ID:
  return corresponding t
```

FIG. 21 illustrates an execution flow diagram 2100 in accordance with one embodiment. The execution flow diagram 2100 may begin with move arms to start position 2102, so that the articulated robot arms are in an intended initial position. This may be the same as a default home position for each articulated robot, or may be a pose optimized for the next expected action based on awareness of an entire motion plan and picking sequence. The execution flow diagram 2100 may get picking poses 2104 by sending a signal to request picking pose from detection cache 2106.

If a picking pose available 2108 indicates a picking pose is not available, the detection cache flow diagram 1900 may return to the get picking poses 2104 step. If a picking pose is available, the execution flow diagram 2100 may perform a move conveyor 2110 step if needed to move the loading conveyor between up, center, and down positions to bring the articulated robots into a position appropriate to the picking pose. The planner flow diagram 2000 may then request motion plan trajectories from planner 2112. A motion plans available 2114 check may indicate no plans are available, at which point the request motion plan trajectories from planner 2112 step may be repeated. If plans are available, these plans may be executed.

In one embodiment, executing the plans includes a first move left arm home, pick with right arm 2116 step, followed by a take picture to the left 2118 step. Next, a pick with left arm, drop with right arm 2120 step may be executed, followed by a drop with left arm, move right arm home 2122 step, then a take picture to the right 2124 step. Based on the pictures taken to the left and right, a wall cleared 2126 check may be performed. If it is determined that the wall has not been cleared, additional picking poses may be obtained.

If it is determined that the wall has been cleared, a move arms to home position 2128 step may be performed, followed by a move conveyor to high position 2130 step, then a move forward 2132 step. A container cleared 2134 check may be made. If the container has not been cleared, the execution flow diagram 2100 may return to the first move arms to start position 2102 step and repeat. If the container has been cleared, the execution flow diagram 2100 may be exited.

For the following parameters:
startPose: This is the start position of the arms (two arrays of six floats describing the joint configuration for each robot)
graspPoses: This is the pair of IDs for the grasp poses
homePose: This is the home position for the arms
dropPose: This is the six dimensional drop pose for the arms
pickPose: This is the pick position for the arms depending on the grasp pose
highPose: This is the highest position for the conveyor
wallCache: vector of all the detections that are close to the system
containerCache: vector of all the detections that do not belong in the wall cache
   pseudocode corresponding to this detection cache flow diagram 1900 may be as follows:

```
while containerCache not empty
  move arms to startPose
  while wallCache not empty
    query detection cache for next pair of graspPoses
    if one of graspPoses is above reachable space
      move conveyor up
    else if graspPoses are below reachable space
      move conveyor down
    endif
    while plan not available
      query for available plan for the graspPoses
    end while
    move left_arm homePose and right_arm pickPose
    take picture of scene with left camera
    move left_arm pickPose and right_arm dropPose
    move left_arm dropPose and right_arm homePose
    take picture of scene with right camera
  end while
  move both arms homePose
  move conveyor to highPose
  move forward
end while
```

FIGS. 22A-22I illustrate a suction gripping apparatus 2200 comprising a suction gripping unit 2202 in accordance with one embodiment. FIG. 22A shows a bottom perspective view, FIG. 22B shows a top perspective view, FIG. 22C shows a bottom plan view, FIG. 22D shows a top plan view, FIG. 22E shows a side elevation view, FIG. 22F shows a side cross-sectional view, FIG. 22G shows a side view with transparent outer elements, FIG. 22H shows a side view of the suction gripping unit 2202 of the suction gripping apparatus 2200 with transparent outer elements in an alternative configuration, and FIG. 22I shows an exploded view.

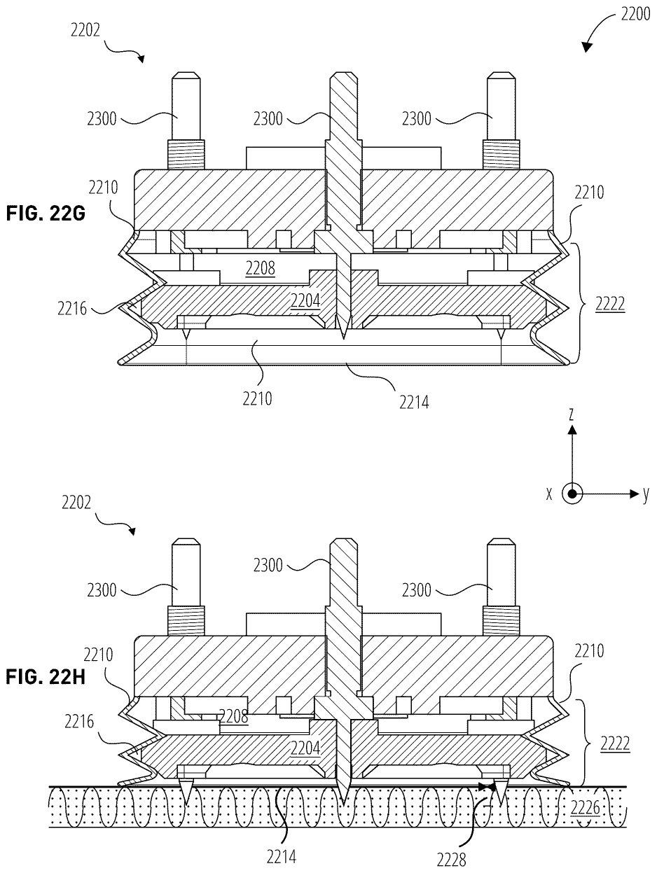

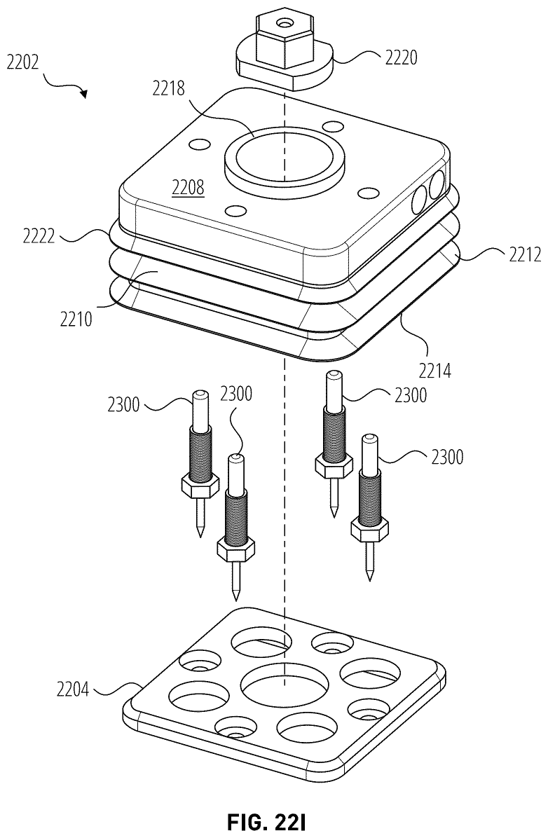

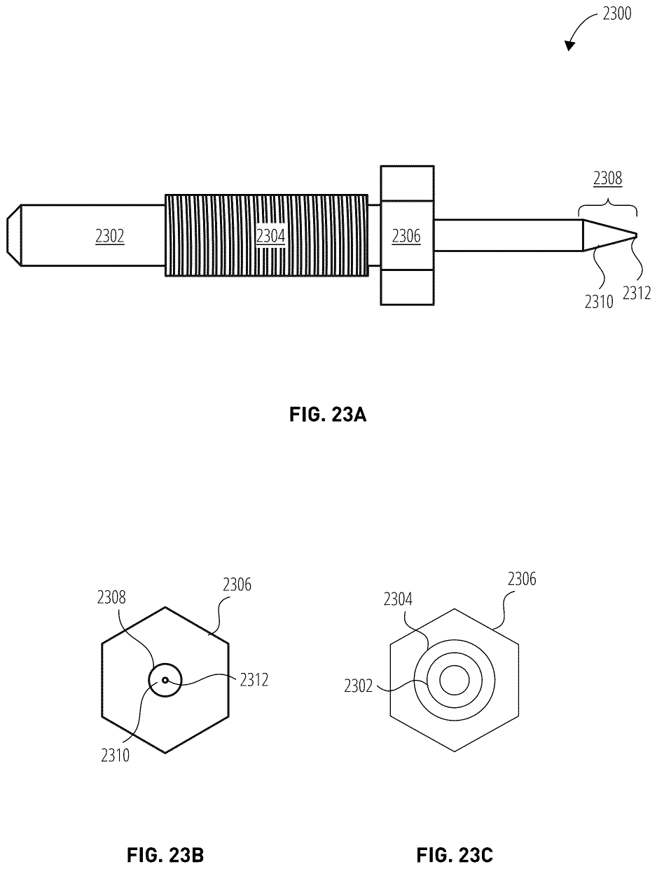

The suction gripping unit 2202 of the suction gripping apparatus 2200 may comprise a plurality of guiding support pins 2300 described in greater detail with respect to FIGS. 23A-23C, as well as a contact surface reinforcement sliding plate 2204 comprising at least one plate orifice 2206 and configured to receive the guiding support pins 2300. The guiding support pins 2300 in conjunction with the contact surface reinforcement sliding plate 2204 may act as novel shear elements that greatly enhance the capabilities of the suction gripping apparatus 2200 when compared to conventional suction cup grippers. The guiding support pin 2300 may be configured as needles or with other end configurations that facilitate piercing, holding, or increasing friction against the surface of an object to be picked.

The suction gripping unit 2202 may further comprise a suction chamber 2208 configured to receive the guiding support pin 2300 and the contact surface reinforcement sliding plate 2204. The suction chamber 2208 may include one or more side walls 2210 that have a contacting edge 2212. The suction chamber 2208 may also include a contact surface 2214 at the contacting edge 2212. The contact surface 2214 may be configured to apply suction force to a pickable object. The suction chamber 2208 may finally include an inner groove 2216, integrated into the side walls 2210 above the contact surface 2214. The inner groove 2216 may be configured to accept the contact surface reinforcement sliding plate 2204. The plate orifices 2206 are in fluid communication with the suction chamber 2208.

The contact surface reinforcement sliding plate 2204 residing within the inner groove 2216 along the entire inner periphery of the side walls 2210 of the suction chamber 2208 may provide significantly beneficial structural stiffness to the side walls 2210 and contacting edge 2212, reinforcing and solidifying contact between the contact surface 2214 and a pickable object. The guiding support pins 2300 may impart improved stability and rigidity to the contact surface reinforcement sliding plate 2204 without sacrificing the flexibility of the material comprising suction chamber 2208, which is important to forming the suction forces under a vacuum. The strength and stability imparted by the support structure formed by the guiding support pins 2300 and contact surface reinforcement sliding plate 2204 also allow the geometry of the disclosed suction gripping unit 2202 to be varied in numerous ways.

The suction chamber 2208 and contact surface reinforcement sliding plate 2204 may be designed having polygonal cross-sections not available in conventional suction cup grippers. In addition to the square cross-section shown for the suction gripping units 2202 and conventionally available square, rectangular, circular, and elliptical suction grippers, the disclosed suction gripping unit 2202 represents a technical improvement over conventional solutions in that it may be designed having regular polygonal cross-sections such as hexagonal, pentagonal, octagonal, etc. Custom, multi-sided configurations are also possible using the contact surface reinforcement sliding plate 2204 and guiding support pin 2300, as well as shapes having multiple points of convex and concave curvature. All of these configurations may be supported without degrading suction or shear force applications, and thus without compromising the performance of the suction gripping apparatus 2200 either as a single suction gripping unit 2202 or an array of suction gripping units 2202.

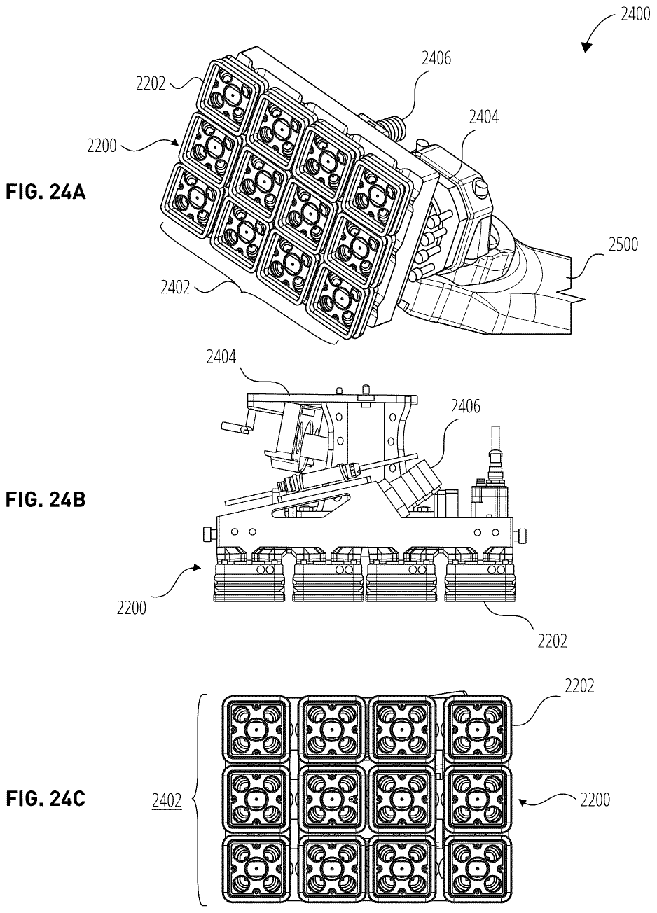

The suction gripping unit 2202 may include a suction port 2218 in fluid communication with the suction chamber 2208. The suction port 2218 may be configured to interface with a vacuum suction system. The suction port 2218 may include a flow restrictor 2220 in one embodiment. In one embodiment, the suction port 2218 may further act as an interface by which the suction gripping unit 2202 may be mounted to a gripping end effector, such as the gripping end effector 2400 illustrated in FIGS. 24A-24C. In one embodiment, the guiding support pins 2300 may provide an additional or alternative mounting interface. In one embodiment, the suction gripping unit 2202 may be mounted to the gripping end effector through additional or alternative features specific to that function.

In one embodiment, the side walls 2210 may include bellows folds 2222 allowing them to contract, shortening the suction chamber 2208, when suction force is applied against a surface of a pickable object. This may be seen in FIG. 22G and FIG. 22H in greater detail. In one embodiment, the suction force applied to the surface of the pickable object may induce the guiding support pins 2300 to protrude past the contact surface 2214 and pierce the surface of the pickable object material 2226. For example, a common pickable object may be a corrugated cardboard box. The guiding support pins 2300 may at the ends within the suction chamber 2208 be configured as needles capable of piercing corrugated cardboard.

The piercing depths of the plurality of guiding support pins 2228, i.e., the depth to which they pierce the pickable object material 2226, may be configured as being the same for each guiding support pin, or one or more of the plurality of guiding support pins 2300 may be mounted or dimensioned such that their pin tips fall along different planes, leading to variations among the piercing depths of the plurality of guiding support pins 2228 of a suction gripping apparatus 2200, within a single suction gripping unit 2202 or across a plurality of suction gripping units 2202.

In one embodiment, the guiding support pins 2300 may penetrate through the contact surface reinforcement sliding plate 2204 through guiding support pin bushings 2224, as indicated in FIG. 22F. These may be low-friction, plastic bushings that are part of the material of the contact surface reinforcement sliding plate 2204, or may be formed separately and inserted and adhered within the contact surface reinforcement sliding plate 2204. These guiding support pin bushings 2224 may facilitate the movement of the contact surface reinforcement sliding plate 2204 along the guiding support pins 2300 along the z axis while maintaining a seal appropriate to support the development of adequate suction force at the contact surface 2214 through application of a suction vacuum within the portion of the suction chamber 2208 between the contact surface reinforcement sliding plate 2204 and a pickable object.

FIG. 23A illustrates a guiding support pin 2300 in accordance with one embodiment. Such guiding support pins 2300 may align and guide the contact surface reinforcement sliding plate that supports and strengthens the contact surface of the suction gripping unit. The guiding support pin 2300 comprises a pin shaft 2302, a shaft threading 2304, a sliding plate z-stop 2306, a pin tip 2308, a taper 2310, and a point 2312.

The pin shaft 2302 may include shaft threading 2304, such as screw threads or a similar configuration, to facilitate mounting the guiding support pin 2300 at a specified depth and/or angle within the suction chamber 2208. In this manner, the location of the sliding plate z-stop 2306 may be adjusted to limit the motion of the contact surface reinforcement sliding plate 2204 along the z-axis, as shown in FIGS. 22A-22I to a desired extent. The shaft threading 2304 may in one embodiment be used in mounting the suction gripping suction gripping unit 2202 upon a gripping end effector.

In the embodiments illustrated in FIGS. 22A-22I, the guiding support pins 2300 are seen to be identically configured as well as coplanar in the z-axis. However, the shaft threading 2304 or other feature used to mount the guiding support pins 2300 within the suction gripping unit 2202 and/or the design of the guiding support pins 2300 may be used to configure different guiding support pins 2300 at different planes along the z-axis. For example, a suction gripping unit 2202 may be configured with an outer ring of guiding support pins 2300 in a circumferential pattern near the periphery of the suction chamber, these guiding support pins ending at a first distance from the contacting edge 2212 when not under suction, and an inner ring ending at a second, larger distance from the contacting edge 2212. This may facilitate the handling of objects having rounded surfaces, or other features less compatible with contact by coplanar guiding support pins 2300.

The guiding support pin 2300 may have a pin tip 2308 that includes various features for improving the gripping capabilities it imparts. In one embodiment, as shown, the pin tip 2308 may have a taper 2310 ending in a sharp or rounded point 2312, allowing the pin tip 2308 to pierce the material making up a pickable object.

FIGS. 24A-24C illustrate a gripping end effector 2400 in accordance with one embodiment. The gripping end effector 2400 comprises a suction gripping apparatus 2200 that includes an array 2402 of suction gripping units 2202, a robot arm attachment interface 2404, a suction hose attachment port 2406, and a robot arm with gripping end effector system 2500.

A suction gripping apparatus 2200 is shown having an array 2402 of twelve suction gripping units 2202, identical in size and geometry, arranged in an evenly spaced three by four grid, but this configuration is not intended to be limiting. The design of the disclosed suction gripping apparatus 2200 facilitates numerous variations upon this arrangement. Suction gripping apparatus 2200 may be arranged with a different size or shape of grid array of suction gripping units 2202. Suction gripping units 2202 may be arranged in full and partially populated grid arrays holding other numbers of suction gripping units 2202. Different sizes of suction gripping units 2202 may be combined to facilitate handling of specific pickable object types and shapes. Different array geometries, such as hexagonal and circular are possible. Different geometries of suction gripping units 2202, such as circular, rectangular, and hexagonal, may be arranged in different array shapes. While the contact surfaces of the suction gripping units 2202 of the suction gripping apparatus 2200 illustrated in FIGS. 24A-24C are shown to be coplanar, the suction gripping apparatus 2200 may vary the planes at which different suction gripping units 2202 are mounted.

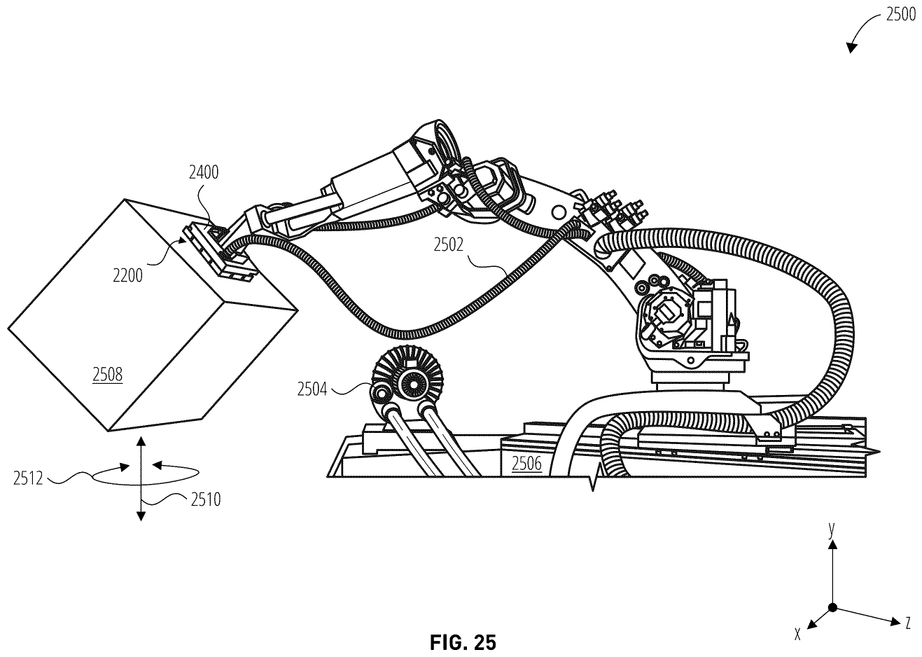

FIG. 25 illustrates a robot arm with gripping end effector system 2500 in accordance with one embodiment. The robot arm with gripping end effector system 2500 comprises a suction gripping apparatus 2200 mounted on a gripping end effector 2400 and a suction hose 2502 connecting the gripping end effector 2400 to a vacuum suction system 2504. The robot arm with gripping end effector system 2500 may be mounted on a picking robot conveyer system 2506 in one embodiment. The robot arm with gripping end effector system 2500 is shown using the gripping end effector 2400 and its suction gripping apparatus 2200 to hold a picked object 2508, i.e., a cardboard box.

A gripping end effector 2400 including a suction gripping apparatus 2200 as shown may greatly improve upon conventional solutions in handling the shear loads encountered in manipulating picked objects 2508. Manipulating a pickable object may include lifting 2510 the pickable object (raising or lowering the object along the y-axis), moving 2512 the pickable object (transporting the object along a plane in the y-axis, traversing across the x- and/or z-axes), and translating the pickable object in all axes simultaneously (i.e., moving 2512 the pickable object in any direction while lifting 2510 the pickable object). Loading during a simultaneous lifting 2510 and moving 2512 operation may be particularly difficult for conventional solutions to adequately overcome. The disclosed suction gripping apparatus 2200 exceeds the performance of conventional solutions during simultaneous lifting 2510 and moving 2512 operations in a test environment.

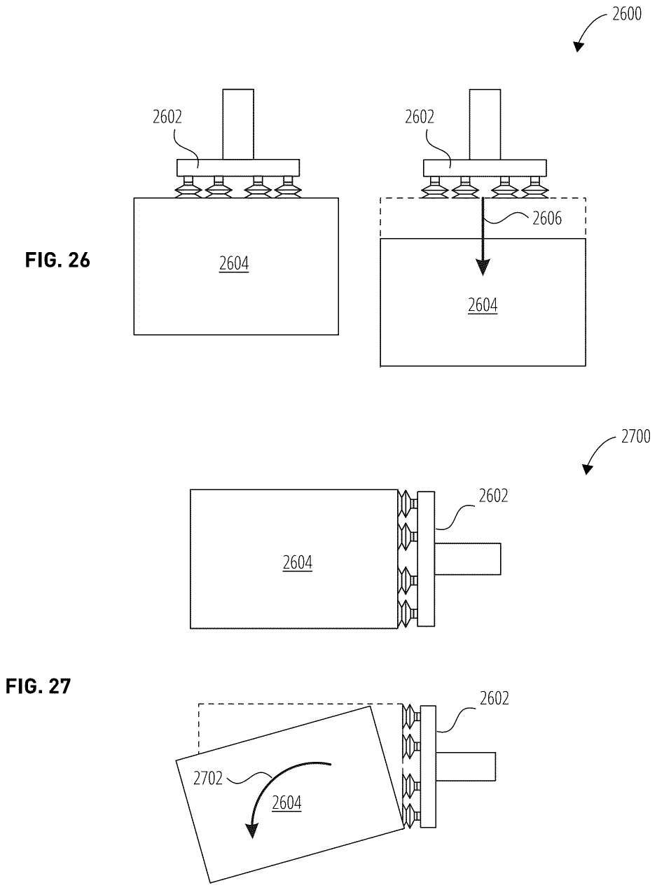

FIG. 26 illustrates a top pick scenario with a conventional suction cup array 2600 in accordance with one embodiment. A conventional suction cup array 2602 may perform a top pick upon a pickable object 2604. A top pick scenario involves picking the pickable object 2604 from the top at a predominantly horizontal face.

In a top pick all cups are loaded in a similar way and are put into “pure tension.” The maximal holding capacity of the gripper is the sum of all holding capacities of the suction cups on the gripper. Picking about the center of gravity and a perfect box may be assumed when modeling a top pick scenario with a conventional suction cup array 2600. If the holding capacity of the aggregated suction cups is insufficient, the conventional suction cup array 2602 may vertically drop 2606 the pickable object 2604.

FIG. 27 illustrates a side pick scenario with a conventional suction cup array 2700 in accordance with one embodiment. A conventional suction cup array 2602 may perform a side pick upon a pickable object 2604. A side pick scenario involves picking from the side at a predominantly vertical face.

In a side pick The box generates a moment that wants to ‘peel away’ the box from the gripper. In this case the top row of suction cups is an important component as it holds the longest “lever arm” and contributes the most to the overall strength. The bottom suction cups of the gripper are even in compression and don't contribute at all, apart from providing an end stop for the box. If the holding capacity of the aggregated suction cups is insufficient, the conventional suction cup array 2602 may rotationally drop 2702 the pickable object 2604.

Any combination of vertical forces associated with a top pick scenario and horizontal forces and moments associated with a side pick scenario may be experienced at the gripper during robotic motion. In general, the side pick is the much more challenging condition for the gripper, with about 50% of the holding capacity as compared to the top pick, assuming the pickable object 2604 is picked on the same face. However, side picks are needed to pick boxes from containers, as sometimes the boxes are stacked up to the ceiling and there is no access to them from the top.

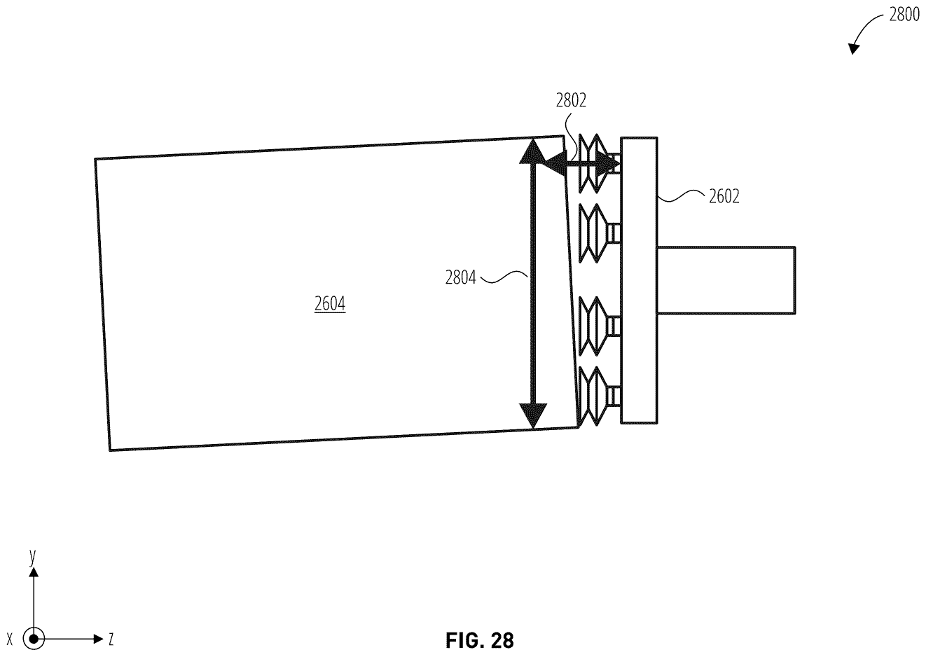

FIG. 28 illustrates attachment forces during a side pick scenario 2800 in accordance with one embodiment. Generally speaking, when a conventional suction cup array 2602 is in suction contact with the surface of a pickable object 2604, two primary forces may be applied by the conventional suction cup array 2602 in order to counteract the vertical forces and the horizontal forces and moments, as previously described. Tensile force 2802 is applied by the conventional suction cup array 2602 normal to the surface of the pickable object 2604 of the suction cups (the z-axis in the illustrated example). Shear force 2804 is applied in the vertical plane (the y-axis), as shown.

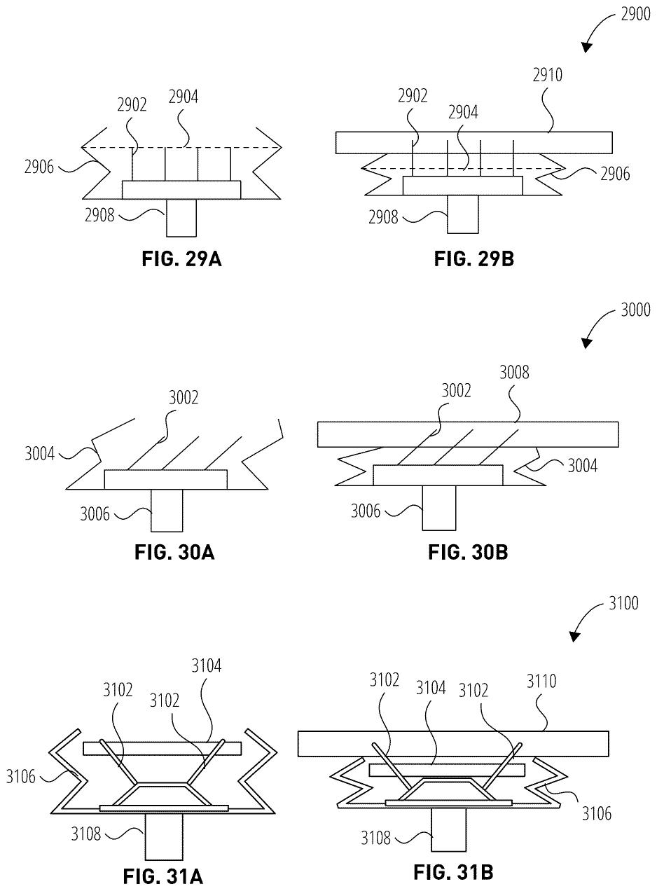

FIGS. 29A-29B illustrate a suction gripping apparatus 2900 in accordance with one embodiment. The suction gripping apparatus 2900 comprises guiding support pins 2902, a contact surface reinforcement sliding plate 2904, side walls 2906, and a plunger 2908, and is configured to grip a pickable object surface 2910. Special suction cups that have the guiding support pins 2902 in the form of needles embedded in the area that is under vacuum. This has the advantage that cardboard is sucked onto the needles and the force on the cardboard is directly applied where the needles are aligned axially. This approach may give the most reliable embedding of needles into cardboard. The compression of the cup under vacuum again is the mechanism to pull the needles into the cardboard.

The solution may have the following functions/features:
The needles may be rigidly connected to the attachment point of the suction cup. This guarantees a good force transfer between the needles and the gripper itself.
The needles may be straight or at an angle.
The needles may be directly connected to the gripper body and a spacer with holes for the needles is connected to the bellows of the cup. This way the needles are retracted and protected when the cup is not active. When the cup is activated and compresses, the needles are extended out and into the cardboard.
If the tolerance between needles and the spacer may be made right, it has the additional functionality of cleaning the needles off any cardboard residue.

FIGS. 30A-30B illustrate a suction gripping apparatus 3000 in accordance with one embodiment. The suction gripping apparatus 3000 comprises guiding support pins 3002, side walls 3004, and a plunger 3006, and is configured to grip a pickable object surface 3008. Special suction cups that have the guiding support pins 3002 in the form of needles embedded in the area that is under vacuum.

If the needles are at an angle relative to the cup plane the problem might be that the cup pushes a needle at an angle straight into the cardboard. For this reason, the cardboard may be damaged when embedding the needle, potentially compromising the holding capacity. In order to improve on this, asymmetric bellows for the side walls 3004 that compress at an angle similar to the angle of the needles may be used. Other solutions to this issue are described with respect to FIGS. 31A-31B.

FIGS. 31A-31B illustrate a suction gripping apparatus 3100 in accordance with one embodiment. The suction gripping apparatus 3100 comprises guiding support pins 3102, a contact surface reinforcement sliding plate 3104, side walls 3106, and a plunger 3108, and is configured to grip a pickable object surface 3110.

There is a plunger that moves in and out with the activation of the suction cup. The needles are at an angle to the plunger in a guide. As the plunger moves, activated by the suction motion of the cup, the needles are pushed outwards in an angle. This design is flexible and allows for needles pushing in one direction or as shown in multiple directions. This may help to resist force in any direction as well provide additional holding strength.

A mechanism that rotates the needles in. Either slightly curved needles that match the curvature of the insertion rotation or straight needles that are oriented tangentially to the curvature of the motion.

Various mechanisms may use the mechanical collapsing displacement of the suction cup to create new methods of having micro mechanisms that interface (“Puncture”) the corrugated interface.

While this disclosure has been described with reference to illustrative embodiments, this description is not intended to be construed in a limiting sense. Various modifications and combinations of the illustrative embodiments as well as other embodiments of the disclosure will be apparent to persons skilled in the art upon reference to the description.

### LISTING OF DRAWING ELEMENTS

100 automated ULD unloading system
102 ULD
104 MTBH in the ULD
106 discharged MTBH
108 individual MTBH
110 lifting and tilting mechanism
112 staging interface
114 open-access picking region
116 singulation mechanism
118 primary robotic handling system
120 articulated robot with at least six degree of freedom
122 robotic end effector
124 perception system
126 transfer system
128 defined flow path
130 scanning station
132 downstream sorting and loading system
134 multi-axis gantry robotic system
136 destination-specific container
138 flow of full ULDs
140 flow of empty ULDs
142 flow of empty carts
144 flow of loaded carts
200 routine
202 block
204 block
206 block
208 block
210 block
212 block
214 block
216 block
218 block
220 block
222 block
224 block
300 ULD unloading process
302 step
304 step
306 step
308 step
310 step
312 step
314 step
316 step
318 step
320 step
322 transported
324 first orientation
326 motorized frame
328 elevates
330 discharge height
332 ground level
334 pivoting conveyor
336 rotate
338 discharge orientation
340 rotate
342 gravity-assisted discharge
344 tilt
346 repositioned
348 multi-layer accumulation
350 reduced-height distribution/single-layer distribution
352 lifted and not tilted position
354 move
356 lowers
358 transported
360 places
362 place
364 transported
366 lifts
368 pivot
400 multi-axis gantry robotic system with gripping end effectors
402 external suction hose
404 internal suction conduit
406 end effector support
500 automated ULD unloading system
600 automated ULD unloading system array
700 robotic unloading system array
800 robotic unloading system
802 articulated robot
804 loading conveyor
806 grounded base
808 telescoping transport conveyor
810 scanning station
812 sorting MHE
814 incline MHE
816 empty cart
818 at least partially stacked cart
820 AMR
822 container loading robot
824 container loading robot support gantry
900 robotic handling system
902 first loading conveyor end
904 robot-mounted camera
906 end effector
908 robot base
910 second loading conveyor end
912 base support
914 grounded base pivot
916 wheels
918 tracks
920 loading conveyor pivot
922 translational actuator
924 mounting gantry
926 forward-sensing multidimensional sensor system
928 multi-channel inertia measurement system
930 sensor cutout
932 motor
934 industrial control box
1000 computer system
1002 processor
1004 input devices
1006 memory
1008 output devices
1010 storage devices
1012 network interface
1014 AI-based control logic
1016 model
1100 MTBH calculated picking data
1102 first wall of MTBH
1104 second wall of MTBH
1106 picking face
1108 picking face
1110 picking face
1112 picking position
1114 picking position
1116 picking position
1118 picking orientation
1120 picking orientation
1122 picking orientation
1200 unloading control system
1202 perception systems
1204 industrial control systems
1206 computer system
1208 camera systems
1210 load cell
1212 pressure sensor
1214 other sensors
1216 pneumatics
1218 hydraulics
1220 encoders
1222 motors
1300 container loading control system
1302 perception systems
1304 industrial control systems
1306 computer system
1308 camera systems
1310 load cell
1312 pressure sensor
1314 other sensors
1316 pneumatics
1318 hydraulics
1320 motors
1400 load stabilization control system
1402 perception systems
1404 industrial control systems
1406 computer system
1408 camera systems
1410 location sensor
1412 other sensors
1414 pneumatics
1416 hydraulics
1418 motors
1500 end-to-end control system diagram
1502 control communication
1504 mobile transport fleet manager
1506 wireless fleet control
1508 stored unloading data
1510 container inventory
1512 picking sequence
1514 picking rate
1516 stored palletization data
1518 incoming box sequence
1520 sortation logic
1522 pallet status
1524 current MTBH quantity per pallet
1526 flow control feedback loop
1528 rate
1530 rate data
1532 automated cart loader
1534 automated crane storage and retrieval system
1600 automated truck unloading routine
1602 block
1604 block
1606 block
1608 block
1610 decision block
1612 block
1614 block
1616 block
1618 block
1620 decision block
1622 block
1624 decision block
1626 block
1628 block
1630 decision block
1632 block
1700 pick routine for individual articulated robot
1702 block
1704 block
1706 block
1708 block
1710 block
1712 block
1714 block
1716 block
1718 block
1720 block
1722 block
1800 automated truck unloading flow diagram
1802 full wall scanning
1804a move conveyor down
1804b move conveyor middle
1804c move conveyor up
1806 process left and right images
1808 generate detection cache
1810 update detection cache
1812 generate motion plans
1814 cache motion plans
1816 move conveyor
1818 perform a pick
1820 execute trajectories
1822 update world state
1824 wall cleared
1826 move to next wall
1828 container cleared
1900 detection cache flow diagram
1902 waiting to receive data on MTBH detection
1904 MTBH detection
1906 detection available
1908 order and filter detection
1910 part of wall
1912 wall cache
1914 wall cache empty
1916 switch container cache to wall cache
1918 container cache
1920 get new picking pose pair IDs
1922 picking pose pair plan
1924 picking pose pair IDs
1926 picking pose pair IDs
2000 planner flow diagram
2002 requested pair of picking poses from detection cache
2004 wait for requested poses
2006 pose available
2008 dual arm trajectory planner
2010 plan available
2012 send trajectory to cache
2014 request picking pose IDs from detection cache
2016 output plan trajectories for requested picking pose pair
2100 execution flow diagram
2102 move arms to start position
2104 get picking poses
2106 request picking pose from detection cache
2108 picking pose available
2110 move conveyor
2112 request motion plan trajectories from planner
2114 motion plans available
2116 move left arm home, pick with right arm
2118 take picture to the left
2120 pick with left arm, drop with right arm
2122 drop with left arm, move right arm home
2124 take picture to the right
2126 wall cleared
2128 move arms to home position
2130 move conveyor to high position
2132 move forward
2134 container cleared
2200 suction gripping apparatus
2202 suction gripping unit
2204 contact surface reinforcement sliding plate
2206 plate orifice
2208 suction chamber
2210 side wall
2212 contacting edge
2214 contact surface
2216 inner groove
2218 suction port
2220 flow restrictor
2222 bellows fold
2224 guiding support pin bushing
2226 pickable object material
2228 piercing depth of the plurality of guiding support pins
2300 guiding support pin
2302 pin shaft
2304 shaft threading
2306 sliding plate z-stop
2308 pin tip
2310 taper
2312 point
2400 gripping end effector
2402 array
2404 robot arm attachment interface
2406 suction hose attachment port
2500 robot arm with gripping end effector system
2502 suction hose
2504 vacuum suction system
2506 picking robot conveyer system
2508 picked object
2510 lifting
2512 moving
2600 top pick scenario with a conventional suction cup array
2602 conventional suction cup array
2604 pickable object
2606 vertically drop
2700 side pick scenario with a conventional suction cup array
2702 rotationally drop
2800 attachment forces during a side pick scenario
2802 tensile force
2804 shear force
2900 suction gripping apparatus
2902 guiding support pin
2904 contact surface reinforcement sliding plate
2906 side wall
2908 plunger
2910 pickable object surface
3000 suction gripping apparatus
3002 guiding support pin
3004 side wall
3006 plunger
3008 pickable object surface
3100 suction gripping apparatus
3102 guiding support pin
3104 contact surface reinforcement sliding plate
3106 side wall
3108 plunger
3110 pickable object surface

What is claimed is:

1. An automated system for unloading and sorting Material to be Handled (MTBH) from a Unit Load Device (ULD), comprising:
a lifting and tilting mechanism configured to:
receive the ULD in a first orientation;
elevate the ULD to a discharge height; and
rotate the ULD to a discharge orientation to initiate a gravity-assisted discharge of the MTBH;
a staging interface positioned adjacent to the lifting and tilting mechanism and configured to:
receive discharged MTBH from the ULD; and
maintain the discharged MTBH within an open-access picking region accessible from above;
wherein the lifting and tilting mechanism and the staging interface are configured to operate in coordination such that the gravity-assisted discharge of the MTBH occurs in a controlled manner that preserves pickable surfaces of individual MTBH within the open-access picking region;
a singulation mechanism associated with the staging interface and configured to reduce a multi-layer accumulation of the discharged MTBH into at least one of a reduced-height distribution or a single-layer distribution of the discharged MTBH that is suitable for robotic picking;
a primary robotic handling system positioned over the open-access picking region and comprising at least one multi-axis robot having a robotic end effector configured to identify, engage, and remove the individual MTBH from the staging interface based on a detected position and a detected orientation;
a perception system configured to:
generate spatial data representing at least the detected position and the detected orientation of the individual MTBH within the open-access picking region; and
provide the spatial data to the primary robotic handling system for pick planning;
a transfer system configured to:
receive each individual MTBH removed from the staging interface by the primary robotic handling system; and
transport each individual MTBH along a defined flow path;
a scanning station disposed along the defined flow path and configured to extract identification data associated with each individual MTBH; and
a downstream sorting and loading system configured to:
receive each individual MTBH from the transfer system; and
place each individual MTBH into one of a plurality of destination-specific containers based on the identification data extracted by the scanning station.

2. The automated system of claim 1, wherein the lifting and tilting mechanism comprises a motorized frame with adjustable tilt angles to control a discharge flow rate of the gravity-assisted discharge of the MTBH from the ULD.

3. The automated system of claim 2, wherein the adjustable tilt angles range from approximately 15 degrees to 45 degrees.

4. The automated system of claim 1, further comprising a pivoting conveyor configured to abut the ULD and rotate in coordination with the ULD during a lifting and tilting operation to prevent the MTBH in the ULD from falling out and sustaining damage prior to reaching the discharge height.

5. The automated system of claim 1, wherein the at least one multi-axis robot comprises an articulated robot with at least six degree of freedom (DOF) configured to handle an unstructured MTBH arrangement on the staging interface.

6. The automated system of claim 1, wherein the at least one multi-axis robot comprises a multi-axis gantry robotic system designated for handling a single layer of the discharged MTBH.

7. The automated system of claim 1, wherein the downstream sorting and loading system utilizes a multi-axis gantry robotic system to handle structured palletization of the MTBH into the destination-specific containers.

8. The automated system of claim 1, further comprising a re-orientation station positioned along the transfer system configured to adjust an orientation of each individual MTBH prior to a container loading operation.

9. The automated system of claim 8, wherein the re-orientation station utilizes at least one of mechanical paddles, rotating belts, and robotic arms to adjust the orientation of each individual MTBH.

10. The automated system of claim 1, wherein the perception system comprises at least one of an RGB camera, a depth sensor, and a LIDAR sensor.

11. The automated system of claim 1, wherein the robotic end effector utilizes a hybrid design combining a suction mechanism and a mechanical support mechanism.

12. The automated system of claim 11, wherein the robotic end effector includes a suction gripping apparatus, the suction gripping apparatus comprising:
a suction gripping unit, comprising:
a plurality of guiding support pins;
a contact surface reinforcement sliding plate comprising at least one plate orifice, the contact surface reinforcement sliding plate configured to receive the plurality of guiding support pins and to provide reinforcement to the suction gripping unit during an action of suction;
a suction chamber configured to receive the plurality of guiding support pins and the contact surface reinforcement sliding plate, the suction chamber comprising:
at least one side wall including a contacting edge;
a contact surface at the contacting edge, the contact surface configured to apply a suction force to a pickable object; and
an inner groove, integrated into the at least one side wall above the contact surface, the inner groove configured to accept the contact surface reinforcement sliding plate,
wherein the at least one plate orifice is in fluid communication with the suction chamber; and
a suction port in fluid communication with the suction chamber, the suction port configured to interface with a vacuum suction system.

13. The automated system of claim 1, further comprising:
a computer system in communication with the perception system, the computer system comprising:
at least one processor;
memory; and
artificial intelligence-(AI)-based control logic stored in the memory that, when executed by the at least one processor, configures the computer system to:
manage a detection cache by receiving the spatial data generated by the perception system for each individual MTBH, ordering and filtering detected MTBH based on the spatial data, and updating the detection cache as each individual MTBH is removed from the staging interface;
perform pick planning for a first articulated robot of the primary robotic handling system by generating, scoring, and caching motion plans determined using the spatial data, picking poses, collision-avoidance constraints, and kinematic feasibility constraints, each motion plan comprising a home trajectory, a pick trajectory, and a drop trajectory for the articulated robot; and
coordinate single-arm execution of a planned pick by selecting a picking pose from the detection cache, controlling execution of a corresponding motion plan by the first articulated robot, preventing collisions with static or dynamic elements within an operating environment, and modifying a picking sequence based on execution outcomes and updates to a virtual representation of the discharged MTBH in the staging interface.

14. The automated system of claim 13, wherein the primary robotic handling system further comprises a second articulated robot, and wherein the AI-based control logic further configuring the computer system to:
identify a plurality of detected MTBH suitable for concurrent picking;
select paired picking poses from the detection cache corresponding to the first articulated robot and the second articulated robot;
generate paired motion plans comprising synchronized home, pick, and drop trajectory segments for the first articulated robot and the second articulated robot; and
coordinate execution of the paired motion plans by synchronizing motion of the first articulated robot and the second articulated robot in time and space to prevent inter-robot interference during simultaneous picking operations.

15. A method for automated unloading and sorting of Material to be Handled (MTBH) from a Unit Load Device (ULD), the method comprising:
receiving a ULD onto a lifting and tilting mechanism in a first orientation;
elevating the ULD, using the lifting and tilting mechanism, to a discharge height;
rotating the ULD, using the lifting and tilting mechanism, to a discharge orientation to initiate a gravity-assisted discharge of the MTBH in the ULD onto a staging interface positioned adjacent to the lifting and tilting mechanism and configured to receive discharged MTBH and maintain the discharged MTBH within an open-access picking region accessible from above;
reducing, using a singulation mechanism associated with the staging interface, a multi-layer accumulation of the discharged MTBH into at least one of a reduced-height distribution or a single-layer distribution of the discharged MTBH that is suitable for robotic picking;
generating, using a perception system, spatial data representing at least a detected position and a detected orientation of each individual MTBH;
providing, to a primary robotic handling system, the spatial data;
performing pick planning, by the primary robotic handling system, using the spatial data;
identifying, engaging, and removing, by the primary robotic handling system using a robotic end effector, each individual MTBH from the staging interface, in accordance with the pick planning;
receiving, by a transfer system, each individual MTBH removed from the staging interface by the primary robotic handling system;
transporting, by the transfer system, each individual MTBH along a defined flow path;
scanning each individual MTBH on the transfer system, using a scanning station disposed along the transfer system, to extract identification data associated with each individual MTBH;
receiving, by a downstream sorting and loading system, each individual MTBH from the transfer system; and
placing, by the downstream sorting and loading system, each individual MTBH into one of a plurality of destination-specific containers based on the identification data extracted by the scanning station.

16. The method of claim 15, further comprising controlling a discharge flow rate of the gravity-assisted discharge of the MTBH from the ULD by adjusting the discharge orientation of the lifting and tilting mechanism across a range of adjustable tilt angles between approximately 15 degrees and 45 degrees.

17. The method of claim 15, further comprising:
abutting a pivoting conveyor against the ULD; and
rotating the pivoting conveyor in coordination with the ULD during a lifting and tilting operation to prevent the MTBH in the ULD from falling out and sustaining damage prior to reaching the discharge height.

18. The method of claim 15, wherein identifying, engaging, and removing each individual MTBH from the staging interface is executed by at least one articulated robot with at least six degree of freedom (DOF) configured to handle an unstructured MTBH arrangement on the staging interface, and wherein receiving and placing each individual MTBH into one of the plurality of destination-specific containers based on the identification data extracted by the scanning station is executed by a multi-axis gantry robotic system configured to perform structured palletization of the discharged MTBH.

19. The method of claim 15, further comprising re-orienting each individual MTBH on the transfer system utilizing at least one of mechanical paddles, rotating belts, and robotic arms prior to receiving and placing the discharged MTBH by the downstream sorting and loading system to ensure alignment with spatial packing rules of the destination-specific containers.

20. The method of claim 15, further comprising:
managing, by a computer system, a detection cache by receiving the spatial data generated by the perception system for each individual MTBH, ordering and filtering detected MTBH based on the spatial data, and updating the detection cache as each individual MTBH is removed from the staging interface;
performing, by the computer system, pick planning for a first articulated robot of the primary robotic handling system by generating, scoring, and caching motion plans determined using the spatial data, picking poses, collision-avoidance constraints, and kinematic feasibility constraints, each motion plan comprising a home trajectory, a pick trajectory, and a drop trajectory for the articulated robot; and
coordinating, by the computer system, single-arm execution of a planned pick by selecting a picking pose from the detection cache, controlling execution of a corresponding motion plan by the first articulated robot, preventing collisions with static or dynamic elements within an operating environment, and modifying a picking sequence based on execution outcomes and updates to a virtual representation of the discharged MTBH in the staging interface;
wherein the computer system comprises:
at least one processor;
memory; and
artificial intelligence-(AI)-based control logic stored in the memory that, when executed by the at least one processor, controls the computer system to manage the detection cache, perform the pick planning, and coordinate the single-arm execution of the planned pick.
